(19) United States
(12) Patent Application Publication
(10) Pub. No.: US 2025/0295108 A1
(43) Pub. Date: Sep. 25, 2025

(54) BIOCOMPATIBLE SPACE-CHARGED ELECTRET MATERIALS WITH ANTIBACTERIAL AND ANTIVIRAL EFFECTS AND METHODS OF MANUFACTURE THEREOF

(71) Applicant: C-POLAR TECHNOLOGIES, INC., Las Vegas, NV (US)

(72) Inventors: Jianliang GONG, Hong Kong (HK); Chun Yin OR, North Vancouver (CA)

(73) Assignee: C-POLAR TECHNOLOGIES, INC., Las Vegas, NV (US)

(21) Appl. No.: 19/231,421

(22) Filed: Jun. 7, 2025

Related U.S. Application Data
(62) Division of application No. 17/877,463, filed on Jul. 29, 2022.
(60) Provisional application No. 63/203,763, filed on Jul. 30, 2021.
(60) Provisional application No. 63/260,146, filed on Aug. 11, 2021.
(60) Provisional application No. 63/260,692, filed on Aug. 29, 2021.
(60) Provisional application No. 63/268,201, filed on Feb. 18, 2022.
(60) Provisional application No. 63/364,113, filed on May 4, 2022.

(51) Int. Cl. A01N 33/12; A01N 25/10; A01P 1/00

(52) U.S. Cl. CPC A01N 33/12; A01N 25/10; A01P 1/00

(57) ABSTRACT

The present disclosure relates to antiviral, antibacterial, virucidal and/or bactericidal space-charge electret materials and compositions comprising space-charge electret materials; methods of making and using the materials, methods of making and using the compositions, methods of evaluating the efficacy of the compositions, methods of measuring and testing the compositions, and methods of developing, creating and making new space-charge electret compositions.

### CROSS-REFERENCE TO RELATED APPLICATIONS

The present application is related to U.S. Provisional Patent Application No. 63/203,763, filed on Jul. 30, 2021, which is hereby incorporated in its entirety. The present application also relates to U.S. Provisional Patent Application No. 63/260,146, filed on Aug. 11, 2021, which is hereby incorporated in its entirety. The present application also relates to U.S. Provisional Patent Application No. 63/260,692, filed on Aug. 29, 2021, which is hereby incorporated in its entirety. The present application also relates to U.S. Provisional Patent Application No. 63/268,201, filed on Feb. 18, 2022, which is incorporated in its entirety. The present application also relates to U.S. Provisional Patent Application No. 63/364,113, filed on May 4, 2022, which is incorporated in its entirety.

### FIELD OF THE INVENTION

The present disclosure relates to the field of antibacterial, antiviral, bactericidal and virucidal materials and methods, in particular to a space-charge electret polymer with antibacterial, antiviral, bactericidal and virucidal effects and its uses in preparing antibacterial, antiviral, bactericidal and virucidal materials.

### BACKGROUND OF THE INVENTION

Microorganisms (such as bacteria, viruses and fungi) are ubiquitous in nature and the global social environment. They are natural decomposers and play various important roles in the global ecosystem. Some of them are essential for vital physiological activities in plants and animals and some can cause different types of diseases. The development of antibacterial, antiviral, bactericidal and/or virucidal materials is of significant importance for saving lives and protecting people from being infected by harmful microorganisms. With the progressively, increasingly frequent outbreaks of new and deadly viruses (such as Ebola, swine flu, bird flu, novel coronavirus (Covid-19)), and concomitant emergence of resistant strains (such as methicillin-resistant Staphylococcus aureus or MRSA), it is ever-pressing and urgent to find new materials and methods of disinfection and microbial eradication to assist in the continuing fight against bacteria and viruses.

### SUMMARY OF THE INVENTION

The present disclosure offers and provides antimicrobial compositions with surprisingly effective antibacterial, antiviral, bactericidal, and virucidal properties. The compositions comprise a space-charge electret material coupled with a hydrophobic material. In select embodiments, the compositions are highly efficacious, biocompatible, and environmentally friendly.

The present disclosure also provides a new method of capturing and killing microorganisms (such as bacteria and viruses) using space-charge electret materials comprising the steps of contact electrification, noncontact electrostatic interaction, and interface lipophilicity. In some embodiments, interface lipophilicity does not refer to simple contact disruption determined by amphipathicity and the degree of hydrophobicity. Another embodiment provides a method of identifying biocompatible space-charge electret materials having effective antibacterial, antiviral, bactericidal and/or virucidal properties based on compatible cationic polymers and textile substrates.

### Positive Charge Density

The space-charge electret materials of the present disclosure have high positive surface charge density. The present disclosure demonstrates that space-charge electret materials with higher positive charge density have increased antibacterial, antiviral, bactericidal and virucidal effects, e.g., as shown in the FIGS. 9-15. In some embodiments, the positive charge density of the space-charge electret material is 9.59 nC cm⁻².

Some embodiments provide a composition comprising a space-charge electret material having
a positive surface charge density of 2-35 nC cm⁻²;
a conductivity less than 6×10⁻⁷ s m⁻¹ within the frequency of 80 kHz; and
a hydrophobic material having a surface energy less than 50 mN m⁻¹.

The high positive charge density of the space-charge electret material plays a key role in both capturing and killing microorganisms (such as bacteria and viruses). Firstly, it contributes to attracting biohazards with negatively-charged proteins via noncontact electrostatic interaction and leading to the increase of collision rate. Then contact electrification occurs when the drifting negatively-charged biohazard collides with the positively-charged electret, leading to a drastic change of electrostatic potential and sudden increase of electrical stress. The strong electrostatic field pins the biohazard on the positively-charged surface tightly, and the generated inhomogeneous electric stress contributes to the shearing off of key viral or microbial proteins of the biohazard. In preferred embodiments of the invention, the high positive charge density of the space-charge electret material is uniform or substantially uniform across the surface area of the material.

### Space-Charge Electret Materials

In some embodiments, the space-charge electret material comprises one or more cationic polymers, such as gelatin, chitosan, cationic peptides, cationic cyclodextrin, cationic dextran, cationic cellulose, polyethylenimine, polylysine, polyamidoamine, poly(amino-co-ester)s and poly[2-(N,N-dimethylamino)ethyl methacrylate]. The cationic polymers can be natural, semi-synthetic, and/or synthetic and their polymer structures can be linear, branched, hyper-branched and/or dendrimer-like. Placement of the cationic bearing groups can be either in the backbone or side chains.

Cationic polymers are advantageous and useful because they can kill bacteria with their unique cationic molecular structures without the release of any chemicals. Their mode of antibacterial action is mainly upon contact to disrupt the microbial cell membrane. The degree of antibacterial activity for a cationic polymer is determined by two factors: amphipathicity and the degree of hydrophobicity.

Example materials of textile substrates include but are not limited to, natural cotton, wool, cellulose, synthetic polyester, nylon and/or their blends. The structures of textile substrates can be knitted, woven and nonwoven. Some embodiments include blended textiles consisting of both hydrophilic natural fibers and hydrophobic synthetic fibers.

The space-charge electret materials of the present disclosure possess both high positive charge density and suitable hydrophobicity and have particularly effective antibacterial, antiviral, bactericidal and virucidal properties. During the tight contact, the hydrophobicity of the space-charge electret material helps its lipophilic partition to insert into the cell membrane of the microbe via Van der Waals interactions, contributing to the destruction of biohazards more easily and quickly.

In some embodiments, a high positive charge density is 9.59 nC cm⁻². As shown in the FIGS. 9-11 and 13, space-charge electret material having a high positive charge density (e.g., 9.59 nC cm⁻²) and suitable wettability (the surface energy shall be between 20 and 61 mJ m⁻² or mN m⁻¹) has excellent antibacterial, antiviral, bactericidal and virucidal effects against Staphylococcus aureus, SARS-229E, SARS-COV-2 and Coxsackievirus B6 with an efficacy of over 98% in 5 minutes.

### Methods of Measuring Space-Charge Density

Another embodiment provides a method for identifying compositions with surprisingly effective antimicrobial properties by evaluating the contact electrification performance of space-charge electret materials by measuring the electrostatic charge of the material. The positive charge density is used for quantitative evaluation of the degree of contact electrification.

One example method for measuring positive charge density of a space-charge electret material includes a double-layered device mainly consisted of a bottom acrylic plate fixed with a 6 cm×6 cm adhesive electrode layer and an upper acrylic plate fixed with an identical-size reference material/electrode layer. Polytetrafluoroethylene (PTFE) film is fixed as reference material.

### Advantageous Properties

The presently disclosed compositions have several significant advantages over current methods.

Current methods of disinfection have different drawbacks. Chemical disinfectants and sanitizers often trigger irritation/toxicity to the skin, mucous membranes, and respiratory system, and most are not biofriendly to human beings for use in direct and/or long-term wear/contact situations, such as for personal protective equipment masks and garments. In addition, they are also not suitable for air purification systems with long-term disinfection and sterilization effects, because of easy evaporation or sweeping caused by their low molecular weight and low surface adhesion.

Metal ions (such as mercury, silver, copper, brass, bronze, tin, iron, lead and bismuth ions) are another kind of antimicrobial agents that can kill or inhibit the growth of microorganisms based on oligodynamic effect. However, simple release of these metal ions could also be deadly for human beings and hazardous for the environment. A less invasive and less toxic way is to dope/incorporate desired metal ions with other materials (such as polymers) in the formation of nanoparticles, fibers, coatings or films. They are not easily removed by simply sweeping, but due to the high surface energy of metals, they are usually covered with lower surface energy materials, resulting in less antibacterial effects.

In contrast, disclosed herein are highly efficacious, biocompatible, environmentally-friendly materials that are able to effectively kill microorganisms and can be used for direct and long-term wear and contact.

The textile substrates treated with space-charge electret materials are efficacious in keeping viruses and bacteria from penetrating through the textile filter. The viral filtration efficacy and bacterial filtration efficacy of cellulose/polyester textile treated with BPEI space-charge electret material has been demonstrated to be over 99.9%.

The antibacterial, antiviral, bactericidal and virucidal space-charge electret material also has excellent biocompatibility by controlling the composition of the material. There was no difference in VERO cell proliferation between untreated and BPEI space-charge electret material-treated textiles. Wash-out from control textiles and space-charge electret material-treated textiles moderately reduced vero E6 cell proliferation. There was no difference in VERO cell proliferation between untreated and C-polar treated textiles, and no cell sensitivity reduction was found. These results demonstrate that space-charge electret materials are safe and suitable for industrial production and large-scale use.

For cationic polymers, hydrophilic cationic-bearing groups contribute to attracting the negatively-charged membrane via electrostatic attraction while hydrophobic alkyl chains help the cationic polymer chain insert into the membrane via hydrophobic and Van der Waals interactions. The degree of hydrophobicity governs the extent of alkyl partitions permeating into the lipid bilayer for destruction of the bacteria. Therefore, different cationic polymers have different levels of antibacterial activity. However, there is still an absence of highly effective quantitative techniques to evaluate the degree of antibacterial activity for a cationic polymer. Moreover, there are few documents on the antiviral and virucidal effects of cationic polymers, particularly for COVID-19, at the present time.

### Uses of Space-Charge Electret Materials

Space-charge electret materials can be widely used for air filtering products (such as masks, protective garments, and air purifiers) and personal/home sanitation and hygiene items, such as hand sanitizers, moist towelettes, and toilet paper, home/hotel textiles, and related disposable items. Space-charge electret can help to cut off the spread of virus among people with high filtration efficiency (passive functions), and self-disinfection (proactive functions) and uses without a concern for triggering collateral environmental pollution or indirect/secondary collateral hazards.

### BRIEF DESCRIPTION OF THE DRAWINGS

FIG. 1 schematically illustrates the disinfection mechanism of space-charge electret material with high positive charge density.

FIG. 2 shows the chemical structures of cationic polymers and their positive charge states used for preparation of space-charge electret materials.

FIG. 3 illustrates the surface modification of textile substrate with space-charge electret materials for high positive charge density.

FIG. 4 illustrates the air filtering and self-disinfection functions of a textile substrate surface modified with space-charge electret materials.

FIG. 5 is a flowchart of surface modification of a textile substrate with BPEI space-charge electret as an example.

FIG. 6 schematically illustrates the charge measurement device for evaluating the positively charged performance of a space-charge electret material and its typical charge curves caused by repetitive contact and separation controlled by repetitively applying and releasing an external force.

FIG. 7 shows the influence of BPEI concentration on the charge density of a BPEI modified textile.

FIG. 8 typically shows the instantaneous output voltage generated when a textile surface modified with high positive charge density space-charge electret material is subject to repeated collisions/contacts.

FIG. 9 shows virucidal performance of different textile substrates treated with different solution concentrations of BPEI space-charge electret material.

FIG. 10 shows the test results of different materials for killing human coronavirus 229E, including tissue, FFP2 filter, FFP2 sponge, Curie Spunlace (i.e., cellulose/polyester textile treated with BPEI space-charge electret material) and Curie Paper (i.e., tissue treated with BPEI space-charge electret material).

FIG. 11 shows the test results of different materials for killing Coxsackievirus B6, including tissue, FFP2 filter, FFP2 sponge, Curie Spunlace (i.e., cellulose/polyester textile treated with BPEI space-charge electret material) and Curie Paper (tissue treated with BPEI space-charge electret material).

FIG. 12 shows that cellulose/polyester textile treated with BPEI space-charge electret material achieves a viral filtration efficacy of over 99.9%.

FIG. 13 shows that cellulose/polyester textile treated with BPEI space-charge electret material kills Staphylococcus aureus with efficacy of over 99.9%.

FIG. 14 shows the test results of different textile substrates treated with BPEI space-charge electret material before and after 60 washes for killing Staphylococcus aureus. 100% cotton plain, 100% cotton after 60 washes, polyester/cotton (65%/35%), polyester/cotton (65%/35%) after 60 washes, polyester/spandex (92%/8%), polyester/spandex (92%/8%) after 60 washes are denoted as Sample nos. #1, #2, #3, #4, #5, and #6, respectively.

FIG. 15 shows that cellulose/polyester textile treated with BPEI space-charge electret material achieves a bacterial filtration efficacy of over 99.9%.

FIG. 16 shows the influence of cellulose textile treated with different concentrations of BPEI space-charge electret materials on the viability of VERO E6 cells.

FIG. 17 shows the influence of cellulose/polyester textile treated with different concentrations of BPEI space-charge electret materials on the viability of VERO E6 cells.

FIG. 18 shows the test results of cytotoxicity of different concentrations of BPEI space-charge electret materials (C-POLAR) on GMK cells (left panel) and MRC5 cells (right panel).

FIG. 19 shows the influence of cellulose textile treated with different BPEI space-charge electret materials on cell sensitivity.

FIG. 20 shows the influence of cellulose/polyester textile treated with different BPEI space-charge electret materials on cell sensitivity.

FIG. 21A shows the test results of ISO 10993-5 (Tests for in vitro cytotoxicity) on textile substrates treated with BPEI space-charge electret material.

FIG. 21B shows test results of ISO 10993-10 (Animal skin irritant test) on textile substrates treated with BPEI space-charge electret material.

FIG. 21C shows test results of ISO 10993-10 (Skin sensitization test) on textile substrates treated with BPEI space-charge electret material.

FIG. 22 shows a process of loading space-charge electret material on the surface of a textile substrate material.

FIG. 23 is a general flowchart and preferred embodiment of design and fabrication of space-charge electret materials with high charge density based on cationic polymers for a broad range of antibacterial, antiviral, bactericidal, and virucidal applications.

FIG. 24A schematically illustrates hydrogen bonding of linear PEI with a fiber substrate (an example of a hydrophobic material), according to a preferred embodiment.

FIG. 24B schematically illustrates hydrogen bonding of branched PEI with a fiber substrate (an example of a hydrophobic material), according to a preferred embodiment.

FIG. 25A schematically illustrates the mechanism by which three silyl-linkers are bonded to a fiber substrate (an example hydrophobic material) and to each other via single-O-linkers; and then bonded with linear PEI via epoxide ring-opening, according to an example embodiment.

FIG. 25B schematically illustrates the mechanism by which three silyl-linkers are bonded to the fiber substrate (and exemplary hydrophobic material) and to each other via single-O-linkers; and then bonded with branched PEI via epoxide ring-opening, according to an exemplary embodiment.

FIG. 26A schematically illustrates process steps for bonding a cationic polymer of the present disclosure with textile/fiber (i.e., fiber substrate material), according to an exemplary embodiment.

FIG. 26B shows an example schematic of bonding a branched cationic polymer with a fiber substrate material, according to an exemplary embodiment.

FIG. 27A shows exemplary synthetic routes for making various silylated linear PEI compounds via silylation of linear PEI, according to an exemplary embodiment.

FIG. 27B shows an exemplary synthetic route for making various silylated branched PEI compounds via silylation of branched PEI, according to an exemplary embodiment.

FIG. 27C shows the synthetic route for reacting silylated linear PEI with a fiber substrate (an exemplary hydrophobic material), according to an exemplary embodiment.

FIG. 27D shows the synthetic route for reacting silylated branched PEI with a fiber substrate (an exemplary hydrophobic material), according to an exemplary embodiment.

### DETAILED DESCRIPTION OF THE INVENTION

The present application is described in detail below in conjunction with figures and specific embodiments to enable a person of ordinary skill in the art to make and use the various embodiments. Descriptions of specific devices, techniques, and applications are provided as examples. Various modifications to the examples described herein will be readily apparent to those of ordinary skill in the art, and the general principles defined herein may be applied to other examples and applications without departing from the spirit and scope of the present invention. Thus, the disclosed invention is not intended to be limited to the examples described herein and is to be accorded the full breadth and scope consistent with the claims.

### Definitions

Unless defined otherwise, all technical and scientific terms used herein have the same plain meanings as commonly understood by one of ordinary skill in the art of the present application. The terms used in the description of the present application are for the purpose of describing or explaining particular embodiments only and are not intended to be limiting the present application. As used herein, the term “and/or” comprises any and all combinations of one or more of the associated listed items.

Furthermore, the technical features referred to in various embodiments of the present application described below may be combined with each other as long as they do not contradict or conflict with each other.

As used herein, an “electret” (the word is formed of electr- from “electricity” and -et from “magnet”) refers to a dielectric material that has a quasi-permanent macroscopic electrical field at its surface. It can be divided into two distinct classes of materials: dipolar electret and space-charge electret. Dipolar electrets consist of electric dipoles that are typically otherwise overall electrically neutral, but can lead to a quasi-permanent electric field macroscopically after the alignment of dipoles by external forces (such as via high-voltage polarization). The materials that have a net macroscopic electrostatic charge are defined as space-charge electrets, which can be easily generated by contact electrification. They possess quasi-permanent electrical field upon their surfaces owing to the imbalance of charge. Electrets can be made by first melting a suitable dielectric material, such as a polymer or wax that contains polar molecules, and then allowing it to re-solidify in a powerful electrostatic field. The polar molecules of the dielectric align themselves to the direction of the electrostatic field, producing a dipole electret with a permanent electrostatic bias. Any factors disrupting the alignment of polar molecules will result in the decrease of electrostatic field, such as high temperature. Electrets can also be made by embedding excess charges into a highly insulating dielectric, e.g., by means of an electron beam, corona discharge, injection from an electron gun, electric breakdown across a gap, or via a dielectric barrier.

The present space-charge electret materials with antibacterial, antiviral, bactericidal and virucidal effects possess high positive charge density, amphipathicity, and biocompatibility. In some embodiments, the space-charge electret materials comprise one or more cationic polymers. In certain preferred embodiments, the space-charge electret materials comprising one or more cationic polymers comprise (C-POLAR) linear polyethylenimine (PEI) and/or branched polyethylenimine (BPEI). In some embodiments, the space-charge electret materials do not align molecular poles or embed excess charges. In some embodiments, the space-charge electret materials or cationic polymers have a net electrostatic charge owing to the difference in the number of cationic and anionic charges. In some embodiments, the electric field of the space-charge electret materials can be further enhanced by contact electrification because of the easy transfer of ion groups. In other embodiments, the space-charge electret materials possess amphipathicity. In some embodiments, the space-charge electret materials possess hydrophilic cationic bearing groups and long hydrophobic alkyl chains.

As used herein, the term “space-charge density” or “charge density” refers to the amount of electrical charge per unit surface area or unit contact area. The term “positive space-charge density” or “positive charge density” refers to the total amount of positive charges minus negative charges per unit surface area or unit contact area.

As used herein, the term “conductivity” or “electrical conductivity” refers to a material's ability to resist electric current. In some embodiments, conductivity increases at low frequency. In some embodiments, conductivity decreases at high frequency.

As used herein, the term “resistivity” or “electrical resistivity” refers to a material's ability to conduct electrical current. It is the reciprocal of conductivity or electrical conductivity of the material.

As used herein, the term “surface energy” refers to the excess energy associated with the presence of a surface.

As used herein, the term “hydrophobic material” refers to a material comprising at least one hydroxyl group at the surface that can react with an amino group. The hydroxyl group can be part of the molecular structure itself (such as in the case of polyvinyl alcohol and its derivative copolymers), or the hydroxyl groups can come from water molecules adsorbed on the surface of the material, due to, for example, atmospheric moisture. Most surfaces, regardless of their inherent hydrophobicity, have a thin film of water deposited on their surfaces. Even hydrophobic materials with solid surface energy less than 20 Nm m⁻¹ (such as PTFE and poly(tetrafluoroethylene-cohexafluoropropylene) (FEP)) can adsorb around 1.5-2.0 monolayers of water on their surfaces. In some embodiments, the hydrophobic material is a synthetic polymer. In some embodiments, the hydrophobic material is a synthetic polymer that possesses at least one hydroxyl group. In some embodiments, the synthetic polymer has a more hydrophobic surface and contains less hydroxyl groups. In some embodiments, the synthetic polymer has a solid surface energy between 28 and 48 mN m⁻¹.

In some embodiments, the amino group is part of a silyl-linker of the present disclosure. Hydrophobicity can be measured by methods known to one of skill in the art, such as measuring the contact angle of liquid droplets on the surface of a material or calculating the solid surface energy. In some embodiments, the hydrophobic material is a synthetic polymer or a natural polymer. Examples of synthetic polymers include, but are not limited to, polyethylene (PE), polypropylene (PP) and polyethylene terephthalate (PET). In some embodiments the hydrophobic material includes natural polymer cellulose fibers or fabrics that contain hydroxyl groups. In some embodiments, the hydrophobic material is a mixture of synthetic and natural polymers having a suitable surface wettability. The surface wettability of substrates can be adjusted by blending synthetic and natural polymer fibers. Examples of hydrophobic materials include, but are not limited to cotton, linen, silk, wool, spunlace, chitosan, polyvinyl alcohol, polyvinyl chloride (PVC), polyethylene (PE), polypropylene (PP), polyethyle terephthalate (PET), acrylonitrile butadiene styrene (ABS), poly(methyl methacrylate) (PMMA), aramids (such as nylon), silicone (such as polydimethylsiloxane), latex, glass, semifluorinated polymers and perfluorinated polymers (such as polytetrafluoroethylene (PTFE)). In other embodiments, the hydrophobic material is polyester. “Polyester” is a polymer that contains an ester functional group in every repeat unit of its main chain. Examples include, but are not limited to, polyethylene terephthalate (PET) and polybutylene terephthalate (PBT).

In some embodiments, the hydrophobic material is drawn with one or more hydroxyl groups as shown below. In some embodiments, the hydrophobic material is a fiber substrate material. A fiber substrate material is any material comprising cellulose fibers.

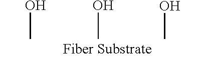

One of skill in the art would understand that the above schematic drawing is not meant to indicate that the hydrophobic material/fiber substrate only has three-OH groups. Instead the drawing is merely illustrative and is meant to encompass many-OH groups, the number depending on the nature of the material.

As used herein, the term “C-POLAR” or “c-polar” refers to a positively charged/cationic polymer that can be applied to a hydrophobic material's surface, e.g., spunlace surface, cotton surface, or polyester surface. In some embodiments, “C-POLAR” or “c-polar” refers to electret materials (agents or solutions) used in the surface modification of textile substrates. In some embodiments, “C-POLAR” or “c-polar” is polyethylenimine (PEI); in some embodiments, “C-POLAR” or “c-polar” is linear polyethylenimine. In some embodiments, “C-POLAR” or “c-polar” is branched polyethylenimine (BPEI). In some embodiments, “C-POLAR” or “c-polar” refers to a range of concentrations of PEI or BPEI. In some embodiments, “C-POLAR” or “c-polar” is 2-30% PEI or BPEI, 2-15% PEI or BPEI, 2-10% PEI or BPEI, 2-8% PEI or BPEI, 2-4% PEI or BPEI, 4-6% PEI or BPEI, 6-8% PEI or BPEI, 2%, 3%, 4, %, 5%, 6%, 7%, or 8% PEI or BPEI. In some embodiments, “C-POLAR” or “c-polar” is 2%, 4%, 6%, 8%, or 10% PEI or BPEI. In some embodiments, “C-POLAR” or “c-polar” is a space-charged electret material. For the sake of clarity, “C-POLAR” or “c-polar” when described together with a textile, such as “C-POLAR spunlace” refers to a composition comprising a cationic polymer and a textile.

As used herein and in the claims, the term “antimicrobial composition” means a composition that is effective (i.e., is in a suitable form and amount) to kill microorganisms or inhibit their growth. In some embodiments, the antimicrobial composition is one or more space-charge electret materials. In some embodiments, the antimicrobial composition is one or more cationic polymers. In some embodiments, the antimicrobial composition comprises C-POLAR or BPEI. In some embodiments, the antimicrobial composition comprises cotton and/or polyester.

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising”, “including,” or “containing,” embodiments.

As used herein, the singular forms “a”, “an” and “the” are intended to include the plural forms as well, unless the context clearly indicates otherwise. Where a range is referred in the specification, the range is understood to include each discrete point within the range. For example, 1-7 means 1, 2, 3, 4, 5, 6, and 7.

As used herein, the term “about” is understood as within a range of normal tolerance in the art and not more than ±10% of a stated value. By way of example only, about 50 means from 45 to 55 including all values in between. As used herein, the phrase “about” a specific value also includes the specific value, for example, about 50 includes 50.

As used herein, the term “cationic polymer” refers to a macromolecule with cationic groups in the polymer backbone and/or in the side chains, such as cationic peptides, (quaternary) ammonium salts, biguanidines, phosphonium salts, guanidines, sulfonium, and pyridinium salts. In some embodiments, cationic polymers bear positive charges macroscopically and lead to a permanent, macroscopic electric field at their surfaces. In some embodiments, cationic polymers are a kind of space-charge electret material. In particular preferred embodiments, the cationic polymers comprise (C-POLAR) linear polyethylenimine (PEI) and/or branched polyethylenimine (BPEI).

As used herein, the term “amphipathicity” refers to the condition of a molecule having both a hydrophilic and hydrophobic regions, such as (in the case of cationic polymers), hydrophilic cationic bearing groups and long hydrophobic alkyl chains.

### Antimicrobial Compositions

One embodiment of the present disclosure provides an antimicrobial composition comprising a space-charge electret material having
a positive surface charge density of 2-35 nC cm⁻²;
a conductivity less than 6×10⁻⁷ s m⁻¹ within the frequency of 80 kHz; and
a hydrophobic material having a surface energy less than 50 mN m⁻¹ or mJ m⁻².

In some embodiments, the positive surface charge density is 5-10, 10-20, greater than 5.5, or greater than 9.59 nC cm⁻².

In some embodiments, the space-charge electret material has a resistivity larger than 1.67×10⁶ Ω·m.

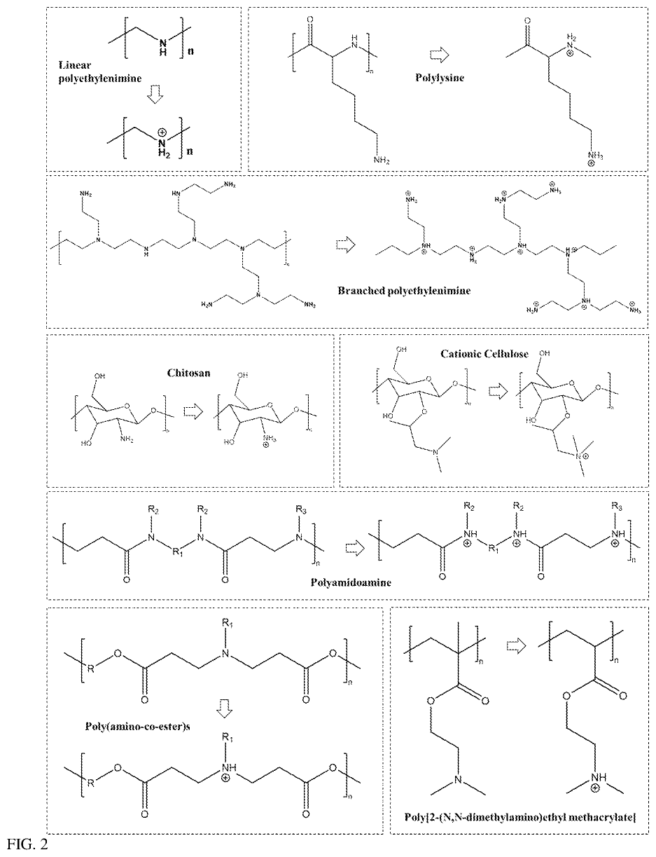

According to another embodiment of the present disclosure, the space-charge electret material is a cationic polymer. In some embodiments, the cationic polymer is natural, semi-synthetic, or synthetic; the cationic polymer has a structure that is linear, branched, hyper-branched or dendrimer-like; and the cationic polymer comprises at least one cationic bearing group that is located in the backbone or the side chain of the polymer. In other embodiments, the cationic polymer is selected from the group consisting of gelatin, chitosan, cationic peptides, cationic cyclodextrin, cationic dextran, cationic cellulose, polyethylenimine (including linear polyethylenimine and/or branched polyethylenimine), polylysine, polyamidoamine, poly(amino-co-ester) s and poly[2-(N,N-dimethylamino)ethyl methacrylate]. In yet other embodiments, the polymer is selected from those listed in FIG. 2 herein.

According to another aspect of the present disclosure, the hydrophobic material's surface comprises cellulose structure having at least two components, and at least one of the components is slightly positively charged in polarity. In some embodiments, at least one of the at least two components has a surface energy less than 50 mN m⁻¹. In some embodiments, the hydrophobic material's surface is highly dense, flat, even, and uniformly positively charged.

### Linkers

In some embodiments, the cationic polymer is bonded to the hydrophobic material via a linker molecule. In some embodiments, the linker is a C₁-C₂₀ aliphatic chain wherein 0, 1, 2, or 3 carbon units of the C₁-C₂₀ aliphatic chain are replaced with one or more heteroatoms selected from the group consisting of —O—, —S—, and —NR—; R is independently H or C₁-C₆ alkyl; and at least one carbon unit of the C₁-C₂₀ aliphatic chain is bonded to a silyl group. In some embodiments, the silyl group is —Si(OR⁺)₂, —Si(R⁺)₂, or —Si(R⁺)(OR⁺); wherein each R⁺ is independently selected from the group consisting of H and C₁-C₆ alkyl; or R⁺ is the silyl group of another linker, wherein the silyl groups of two different linkers are joined together via a single —O— group. In some embodiments, R⁺ is independently H or C₁-C₃ alkyl.

By way of example, the illustration below shows how three silyl-linkers are bonded to the hydrophobic material and to each other via single-O-linkers.

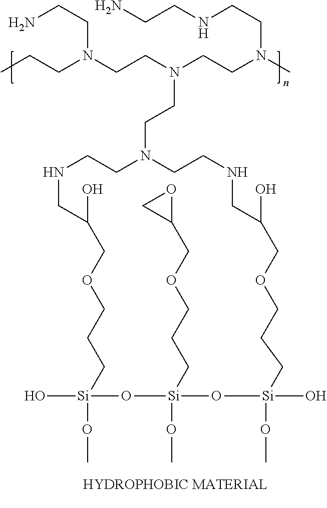

### Si—C Linkers

According to another aspect, the silyl group is bonded to a carbon atom of the linker. In some embodiments, the carbon atom is an end carbon unit of the linker. An end carbon unit is a carbon unit of the aliphatic chain that is only bonded to one other unit in the aliphatic chain. For example, in a C₄ carbon chain, CH₃CH₂CH₂CH₃, the end carbon units would be the first and fourth carbon atoms.

### Si—N Linkers

In some embodiments, the silyl group is bonded to a nitrogen atom of the linker. In some embodiments, the linker is a C₇-C₂₀ aliphatic group wherein 1, 2, or 3 carbon units of the linker are replaced with —NR—, —N═, or —N(R)₂ wherein each R is independently H or C₁-C₆ alkyl.

One of skill in the art would understand which nitrogen group would be an appropriate replacement for a carbon group based on the number of valence groups in the carbon group that is being replaced. For example, in the aliphatic group CH₃CH₂CH═CHCH₂CH₃, the first carbon atom would be replaced by —N(R)₂, the second carbon atom would be replaced by —NR—, while the third carbon atom would be replaced by —N═.

In some embodiments, the linker, together with the cationic polymer is

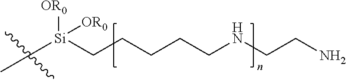

wherein R⁰ is CH₃, CH₂CH₃, CH₂CH₂CH₃, CH(CH₃)₂; and n is 0, 1, 2, 3, or 4.
In some embodiments, n is >0. In some embodiments, n is 1, 2, 3, 4, 5, 6, 7, or 8. In some embodiments, n is >0 and <100. In some embodiments, n is 0-10, 0-20, 0-30, 0-40, or 0-50. In some embodiments, n is 1-20.

### Linker+Cationic Polymer Examples

Additional example embodiments of the linker together with the cationic polymer include

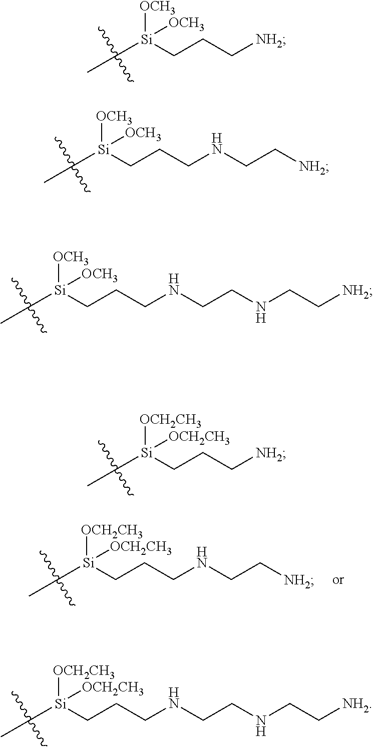 [SMILES: *[Si](CCCN)(OC)OC ; *[Si](CCCNCCN)(OC)OC ; *[Si](CCCNCCNCCN)(OC)OC ; *[Si](CCCN)(OCC)OCC ; *[Si](CCCNCCN)(OCC)OCC ; *[Si](CCCNCCNCCN)(OCC)OCC]

### Other Linkers

According to another aspect, the linker is a C₇-C₁₀ aliphatic wherein one of the carbon units of the linker is replaced with —O—. In some embodiments, the linker is optionally substituted with one or more J groups, wherein J is OR⁰, SR⁰, or N(R⁰)₂, wherein R⁰ is H or C₁-C₆ alkyl. In certain example embodiments, the linker is —Si(OR⁺)₂—(CH₂)₃OCH₂CH(OR⁰) CH₂—.

In other example embodiments, the linker is —Si(OR⁺)₂. In yet other example embodiments, the silyl group is covalently bonded to a hydroxyl group of the hydrophobic material.

### Processes of Modifying Hydrophobic Material Surfaces

Another aspect of the present disclosure provides a process of modifying the hydrophobic material's surface with the space-charge electret material, comprising the following steps:
(a) dissolving the space-charge electret material in a suitable solvent;
(b) introducing a mixture of the space-charge electret material/suitable solvent on the hydrophobic material's surface by dip coating and/or spraying;
(c) removing the suitable solvent by a tensioning process and/or drying in air or at a drying temperature; and
(d) optionally performing one or more systematic tests and evaluations on the hydrophobic material's surface by contact electrification performance evaluation, antiviral test, antibacterial test, virus filtration test and/or bacteria filtration test.

Another aspect of preferred embodiments of the present disclosure is a process of modifying a surface of the hydrophobic material, comprising the following steps:
(a) dissolving the space-charge electret material in a suitable solvent to form a space-charge electret material/suitable solvent mixture;
(b) introducing the space-charge electret material/suitable solvent mixture on the hydrophobic material's surface by dip coating and/or spraying;
(c) subjecting the hydrophobic material to a tensioning process and/or drying the material in air temperature or at a high drying temperature; and
(d) optionally performing one or more systematic tests and evaluations on the hydrophobic material's surface by contact electrification performance evaluation, antiviral test, antibacterial test, virus filtration test, and/or bacteria filtration test.

In some embodiments, the space-charge electret material is branched polyethylenimine (BPEI), linear polyethylenimine (LPEI or PEI), dimethyloctadecyl[3-(trimethoxysilyl) propyl]ammonium chloride, cationic cellulose, didecyldimethylammonium chloride or a combination thereof.

In some embodiments, the space-charge electret material is LEI or BPEI.

In some embodiments, a concentration of the space-charge electret material in the suitable solvent is 0.195%-10%.

In some embodiments, the suitable solvent is water, ethanol or a mixture thereof. In some embodiments, the suitable solvent is water. In select preferred embodiments, the space-charge electret material is dissolved in a solvent with no added salt. In some embodiments, the hydrophobic material is cellulose or cellulose/polyester nonwoven fabrics.

In some embodiments, a tensioning process is applied, wherein the tensioning process includes one or more actions of stretching, steaming, heating, pressing, or subjecting the material to pressure, including high airflow pressure or mechanical pressure. In some preferred embodiments, pressure is applied to the material by adjustable rollers. In some preferred embodiments, heating is provided by an oven.

In some embodiments, the drying temperature is less than 100° C. In some embodiments, the drying temperature is 50° C.-100° C., 100° C.-200° C., 150° C.-200° C., 150° C.-175° C., 175° C.-200° C., 150° C.-170° C., or 155° C.-165° C. In some preferred embodiments, the drying temperature is 160° C.

In some embodiments, the one or more systematic tests and evaluations is/are contact electrification performance evaluation, antiviral test, antibacterial test, virus filtration test, bacteria filtration test or a combination thereof.

### Process of Loading Space-Charge Electret Material

Another aspect of the present disclosure provides a process of loading the space-charge electret material onto a surface of the hydrophobic material, comprising the following steps:
(a) carding at least one of the at least two components to form a drylaid web;
(b) loading the space-charge electret material onto a fabric surface of the drylaid web by high-pressure liquid stream; and
(c) drying and winding up the drylaid web such that the space-charge electret material forms crosslinkers with the fabric surface to form the hydrophobic material's surface.

In some embodiments, the hydrophobic material comprises textile fibers that are knitted, woven, nonwoven, or a mixture thereof. In some embodiments, the textile fibers comprise both hydrophilic natural fibers and hydrophobic synthetic fibers (e.g., blended fibers). In some embodiments, the textile fibers comprise cotton, wool, cellulose, spunlace, synthetic polyester, polypropylene, polyethylene, nylon or a blend of at least two thereof. In some embodiments, the at least one of the components is cotton or polyester. In some embodiments, the other component is cotton or polyester, provided the two components are not identical. In some embodiments, the ratio of the two components is 65% polyester/35% cotton or 50% polyester/50% cotton.

In some embodiments, the cationic polymer comprises 0.195%-15% by weight of the total antimicrobial composition.

### Processes for Preparing Linker Compositions

Some embodiments of the disclosure provide a process of preparing an antimicrobial composition having a linker molecule comprising the following steps:
a) mixing a silylated epoxide compound Ila with a hydrolysis agent in the presence of water to form compound IIb;

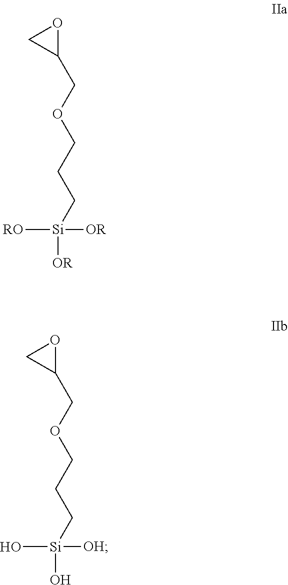

wherein each R is independently C₁-C₆ alkyl;
b) heating compound IIb with hydrophobic material IIc to form compound IId;

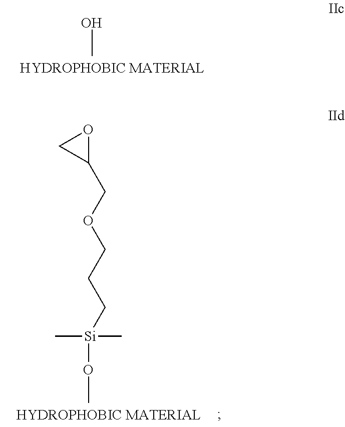

c) combining compound IId with a cationic polymer Ile under epoxide ring-opening conditions;

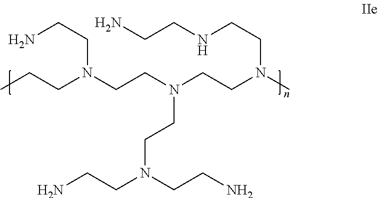

to form an antimicrobial composition of Formula II or II′:

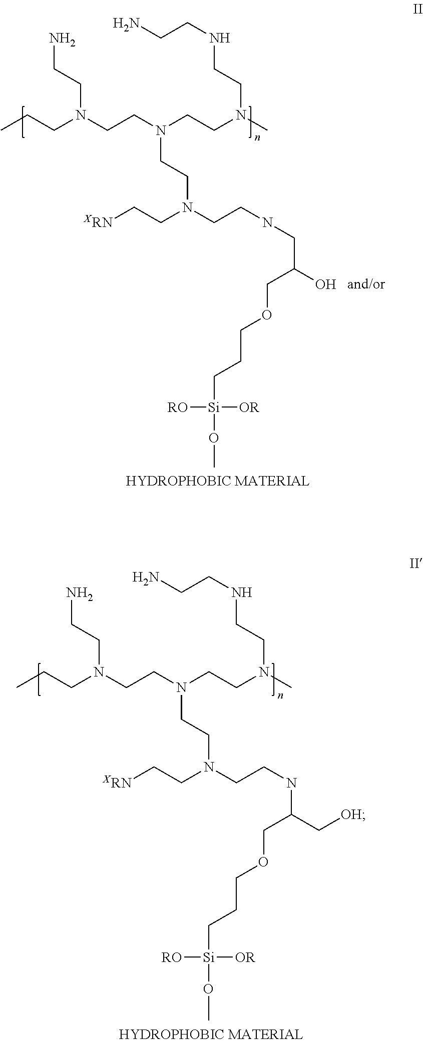

wherein
each R is independently H or C₁-C₆alkyl; or R is the silyl group of another linker, and R^{X} is H or is another linker.

In some embodiments, the another linker is formed via an epoxide ring-opening reaction. In some embodiments, the multiple linkers are attached as shown in the drawing below:

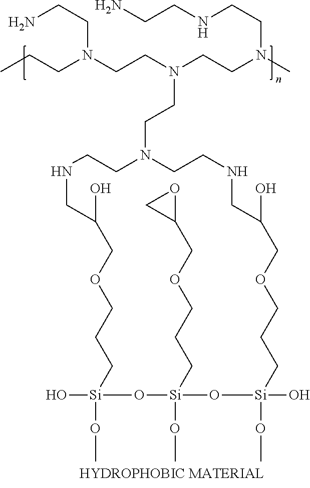

Hydrolysis agents are known to one of skill in the art and may include acids or bases. For the sake of clarity, an acid is a molecule that can donate a proton. Examples include hydrochloric acid (HCl), hydroiodic acid (HI), hydrobromic acid (HBr), perchloric acid (HClO₄), nitric acid (HNO₃) and sulfuric acid (H₂SO₄). In some embodiments, acids together with water are capable of hydrolysing a molecule, i.e., displacing other groups with water molecules. Other embodiments wherein the hydrolysis agent is an acid or a base; weak acid or a weak base; defined as above, also provide examples and ranges from below.

In some embodiments, the hydrolysis agent is “pH-adjusted” water. The water's pH can be adjusted by adding a weak acid (such as acetic acid) or a weak base (such as ammonia) to effect the hydrolysis of Ila to IIb. In some embodiments, the concentration range of acetic acid in water is 0.02%-1%. In other embodiments, the concentration of ammonia is between 0.25-3%. In some embodiments, the hydrolysis reaction is done at a temperature of below 50° C., in some embodiments, from 20-50° C.

Epoxide ring-opening conditions are known to one of skill in the art and typically involve the use of Lewis acids, such as trimethylborane, aluminum oxide and lithium perchlorate. In some embodiments, at least one Lewis acid is added and used as catalyst to activate the ring opening of the epoxide by an amino group of another molecule. In some embodiments, the epoxide ring opening reaction is done at a temperature of 60° C.-150° C. for a duration ranging from 5 minutes to 3 hours. One of skill in the art would know that in some embodiments, the epoxide ring-opening reactions can be conducted without a Lewis acid. For example, in some embodiments, microwave irradiation is used for post-treatment to increase the grafting ratio of linear/branched polyethylenimine onto the surface of modified substrate containing epoxy groups.

Examples of compound of formula IIa are shown below:

| | Compound name | Structure |
|---|---|---|
| IIa-1 | 3-Glycidyloxypropyltrimethoxysilane | 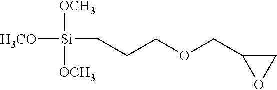 [SMILES: CO[Si](CCCOCC1CO1)(OC)OC] |
| IIa-2 | Triethoxy(3-glycidyloxypropyl)silane | 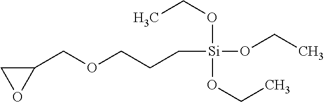 [SMILES: CCO[Si](CCCOCC1CO1)(OCC)OCC] |

The cationic polymers described herein contain many amino groups, and the hydrophobic material treated with the epoxy-silyl linkers (compounds of formula IId) also include several reactive epoxy sites. As such, there are multiple ways in which the amino groups of the cationic polymer can react with the hydrophobic material through the linkers described herein via one or more epoxide ring-opening reactions. Sometimes, two amino groups in the same polymeric repeating unit of the cationic polymer can react with epoxide groups on two different silyl linkers and thus bond to two different hydroxyl groups of the hydrophobic material, as shown in the schematic below.

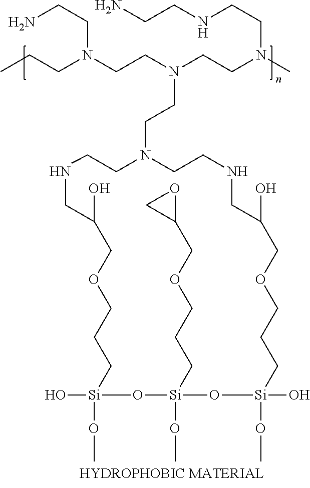

One of skill in the art would understand that there are multiple ways in which the amino groups of the cationic polymer can react with the various epoxide groups in the compounds of formula IId.

Another embodiment of the present invention provides a process of preparing an antimicrobial composition having a linker comprising the following steps:
d) hydrolysing compound IIIa in the presence of water and acid to form compound IIIb;

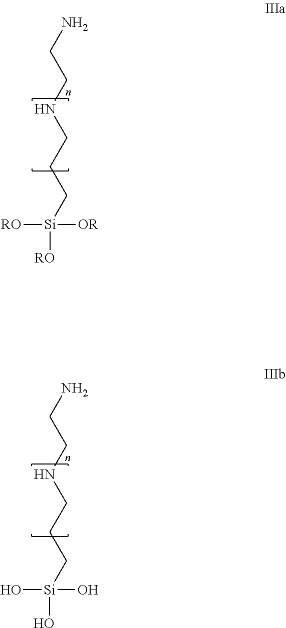

wherein R is an aliphatic group;
e) heating hydrolysed compound IIIb with a hydrophobic material IIIc:

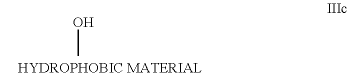

to form an antimicrobial composition of Formula III:

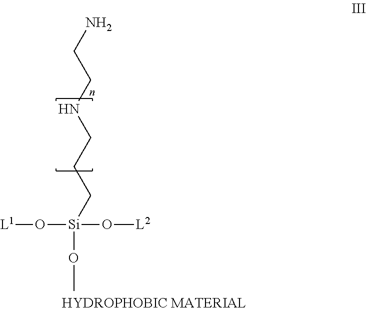

wherein L¹ and L² are each independently H or a silyl group of another linker that is bonded to the same hydrophobic material.

In some embodiments the compound of IIIa is

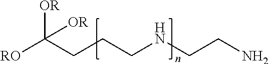

wherein R═CH₃, CH—CH₃, CH₂CH₂CH₃, CH(CH₃)₂; n is 0, 1, 2, 3, or 4.

In some embodiments, the compound of Illa is selected from a compound in Table IIIa.

TABLE IIIa

| Structure | Name |
|---|---|
| 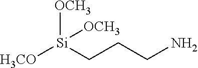 [SMILES: CO[Si](CCCN)(OC)OC] | (3-Aminopropyl)trimethoxysilane |
| 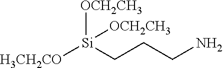 | (3-Aminopropyl)triethoxysilane |
| 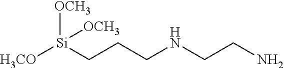 [SMILES: CO[Si](CCCNCCN)(OC)OC] | N-(2-Aminoethyl)-3- aminopropyltrimethoxysilane |
| 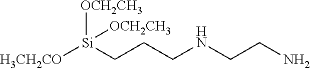 | N-(2-Aminoethyl)-3- aminopropyltriethoxysilane |
| 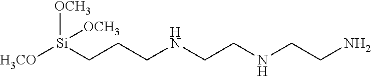 [SMILES: CO[Si](CCCNCCNCCN)(OC)OC] | 3-[2-(2- Aminoethylamino)ethylamino] propyl-trimethoxysilane |
| 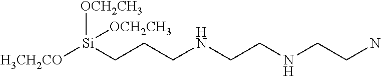 | 3-[2-(2- Aminoethylamino)ethylamino] propyl-triethoxysilane |

In some embodiments, the hydrophobic material IIIc comprises multiple hydroxyl (OH) units, and thus there are multiple ways in which hydrolyzed compound IIIb could react with the hydroxyl groups. In some example embodiments, one or more silyl groups could bond which each other through an oxygen atom, as shown in the schematic below.

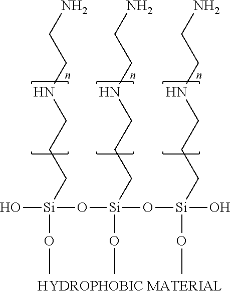

Another aspect of the disclosure provides a process of preparing an antimicrobial composition having a linker comprising the following steps:
a) reacting cationic polymer IVa

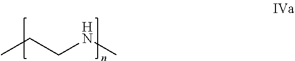

with a silylation agent Z—Cl, wherein
Z is SiR(OR)₂, Si(R)₂(OR), or Si(OR)₃; and
each R is independently C₁-C₆ alkyl;
to form compound IVb; wherein compound IVb is

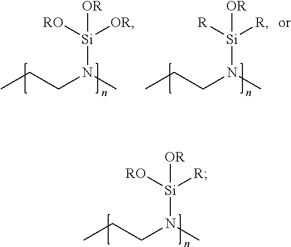

each R is independently C₁-C₆ alkyl;
b) mixing compound IVb with acid in the presence of water to form compound IVc; wherein compounds IVc is

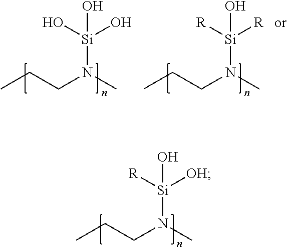

each R is independently C₁-C₆ alkyl;
c) heating compound IVc with a hydrophobic material IVc

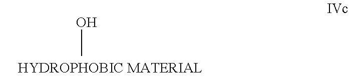

to form the antimicrobial composition of formula IV:

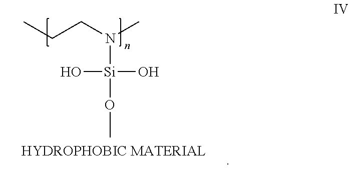

Another aspect of the disclosure provides a process of preparing an antimicrobial composition having a linker comprising the following steps:
a) reacting cationic polymer Va

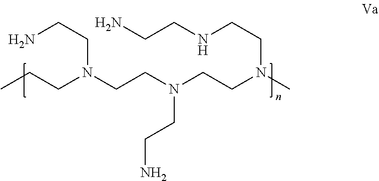

with a silylation agent Z—Cl, wherein
   Z is SiR(OR)₂, Si(R)₂(OR), or Si(OR)₃; and
   each R is independently C₁-C₆ alkyl;
to form compound Vb;
   wherein compound Vb is a compound of formula Va wherein one or more nitrogen units is silylated with one or two Z groups;

b) mixing compound Vb with acid in the presence of water to form compound Vc; wherein compound Vc is a compound of Vb wherein R is H;

c) heating compound Vc with a hydrophobic material Vd comprising at least one OH group;

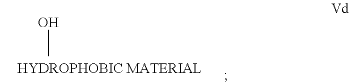

d) to form an antimicrobial composition of applicable claims hereto.

### Silylation Agents

Silylation agents are known to one of skill in the art and are agents that aid in adding a Silyl group to another molecule. In some embodiments, the Silylation Agent is Z—Cl, wherein Z is SiR(OR)₂, Si(R)₂(OR), or Si(OR)₃; and each R is independently C₁-C₆ alkyl;

In some embodiments each R is independently CH₃, CH₂CH₃, CH₂CH₂CH₃, or CH(CH₃)₂.

Example embodiments of antimicrobial compositions having Si linkers are shown in Table V:

TABLE V

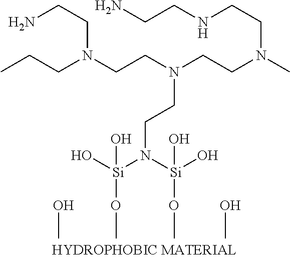

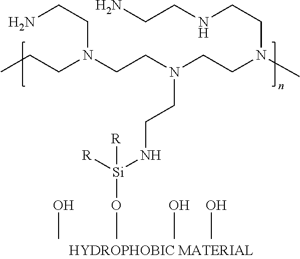

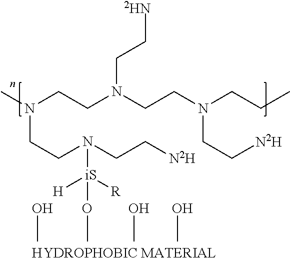

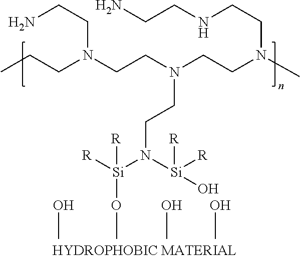

In some embodiments, compound IVb is selected from a compound of Table IV.

TABLE IV

| | |
|---|---|
| 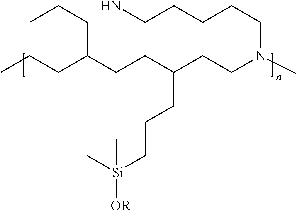 | IVb-1 |
| 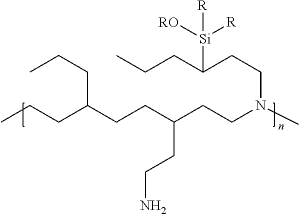 | IVb-2 |
| 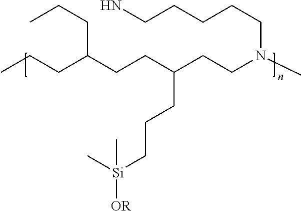 | IVb-3 |
| 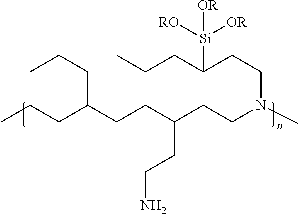 | IVb-4 |
| 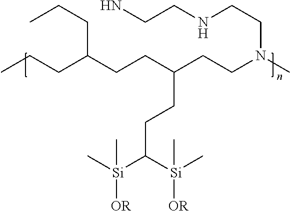 | IVb-5 |
| 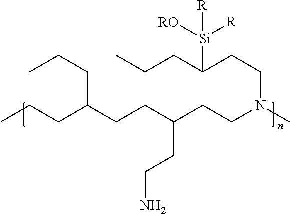 | IVb-6 |
| 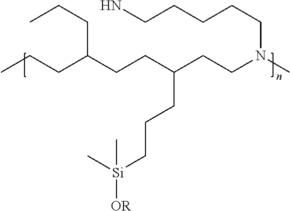 | IVb-7 |
| 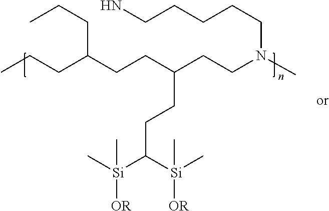 | IVb-8 |
| 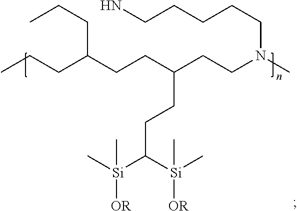 | IVb-9 |

wherein each R is independently C₁-C₆ alkyl.

### Method of Killing Microbes

Another aspect of the present disclosure includes provision a method of killing microbes, comprising the steps of filtering air comprising microbes through the antimicrobial composition of the present disclosure to produce air that is 95% to 99.9% microbe-free. In some preferred embodiments, the air is 99-99.9% microbe-free. In some most preferred embodiments, the air is 99.9% microbe-free.

In some embodiments, the microbes have a mean particle size (MPS) of 1-10 μm. In some embodiments, the microbes have an MPS of 1-5 μm. In some embodiments, the microbes have an MPS of 3.0±0.3 μm.

In some embodiments, the air is moving through the antimicrobial space-charge electret material at an air flow rate of at least 20 L/min. In some embodiments, the air flow rate is 20-50 L/min. In some embodiments, the air flow rate is 28.3 L/min.

In some embodiments, the microbes are bacteria or viruses. In some embodiments, the virus is SARS-COV-2, SARS-229E, Coxackievirus-B6, or influenza. In some embodiments, the bacteria is Staphylococcus aureus.

Another aspect of the present disclosure provides a method of killing microbes comprising the steps of contacting the space-charge electret material with a microbe for an incubation time of at least 1-5 minutes, thereby killing 99.9% of the microbe. In some embodiments, the microbe is bacteria and the incubation time is at least 1 minute. In some embodiments, the microbe is a virus and the incubation time is at least 5 minutes. In some embodiments, the virus is SARS-COV-2, SARS-229E, Coxackievirus-B6, or influenza. In some embodiments, the bacteria is Staphylococcus aureus. For the sake of clarity, “contacting” means bringing the microbes within such proximity to the antimicrobial composition such that the high positive charge density of the space-charge electret material captures and kills the microorganism or microbe as described herein.

### Method of Measuring Space-Charge Density

Another aspect of the present disclosure provides a method of measuring space-charge density on a testing material, comprising the steps of
(a) positioning the testing material between a bottom acrylic plate comprising an adhesive electrode layer and an upper acrylic plate comprising a reference material/electrode layer of a charge measurement device, and an electrometer is connected to the adhesive electrode layer and the reference material/electrode layer and the testing material is adhered to the adhesive electrode layer;
(b) contacting and separating the upper acrylic plate and the bottom acrylic plate repeatedly by a machine while repeatedly measuring the charge value by the electrometer to obtain one or more charge curves;
(c) calculating a charge value difference by subtracting the minimum charge value from the maximum charge value; and
(d) determining the space-charge density on the testing material by dividing the charge value difference by a contact area of the testing material between both the adhesive electrode layer and the reference material/electrode layer.

In some embodiments, the reference material is polytetrafluoroethylene (PTFE) film.

In some embodiments, the adhesive electrode and the reference material/electrode layer have identical size.

### Antimicrobial Products

Another aspect of the present disclosure is the provision of antimicrobial products comprising and incorporating the antimicrobial compositions of any of the preceding embodiments. In some embodiments, the antimicrobial goods product is an air conditioning system, air conditioning unit, air purifier, disinfecting fabric, disinfecting garment (PPE), face mask, reusable disinfecting face mask, air filter, HEPA filter, HEPA filter for electric vehicles, automatic fabric, automotive interior material, disinfecting material, disinfecting clothing, disinfecting glove, or hand sanitizer.

In some embodiments, the two components of the surface of the hydrophobic material are cotton and cellulose; and the space-charge electret material comprises branched/linear polyethyleneimine, chitosan, poly-L-lysine or poly-D-lysine. In some embodiments, the cellulose is polyester; and the space-charge electret material comprises branched polyethylenimine (BPEI) or linear polyethylenimine. In some embodiments, the two components of the surface of the hydrophobic material are 50% cotton and 50% polyester; and the space-charge electret material comprises one or more of 2%, 3%, 4%, 5%, 6%, 7%, 8%, and 9% branched polyethylenimine (BPEI) or linear polyethylenimine. In some embodiments, the two components of the surface of the hydrophobic material are 50% cotton and 50% polyester; and the space-charge electret material comprises 8% branched polyethylenimine (BPEI) or 8% linear polyethylenimine (PEI). In some embodiments, the antimicrobial composition further comprising 8.7% poly(diallyldimethylammonium chloride), 19.7% polyacrylamide; and/or 3.1% ammonium polyphosphate.

### EXEMPLARY EMBODIMENTS OF THE INVENTION

### Methods of Killing Microbes

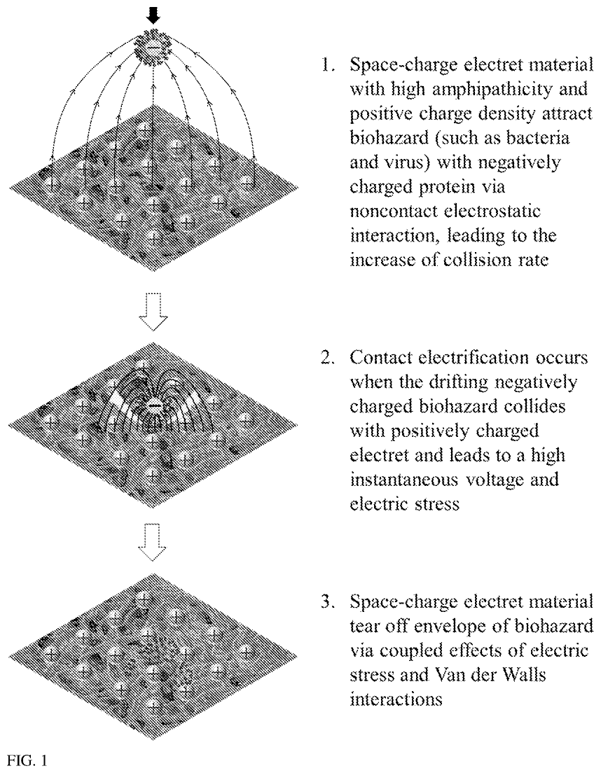

Referring to FIG. 1, the main disinfectant mechanism of space-charge electret materials with high positive charge density for capturing and killing microorganisms (such as bacteria and viruses) is based on coupled and synergistic effects of contact electrification and noncontact electrostatic interaction besides contact disruption determined by amphipathicity and the degree of hydrophobicity. A study conducted by the Weizmann Institute of Science in Israel showed that the net charge of most proteins, such as microorganisms (bacteria and fungi) and viruses, are negatively charged. They are often in the formation of the protein envelope. Firstly, the space-charge electret material with high positive charge density attracts biohazards (such as bacteria and viruses) with negatively charged protein via noncontact electrostatic interaction, leading to an increase of contact/collision rate. Then contact electrification occurs when the drifting negatively charged biohazard collides with positively charged electret, leading to a drastic change of electrostatic potential and sudden increase of electrical stress. The electrostatic field lines leave the high-positive-charge surface of space-charge electret material to seek the negative-charge surface of biohazard very directionally and intensely, creating very inhomogeneous electric stress on the surface of the biohazard. The strong electrostatic field pins the biohazard on the positively-charged surface tightly, and the inhomogeneous electric stress generated thereby contributes to the shearing off of the envelope protein and/or other key viral or microbial proteins of the biohazard. During the tight contact, the hydrophobicity of amphiphilic space-charge electret material also helps its lipophilic partition insert into the membrane via Van der Waals interactions. Therefore, the biohazards can be captured and killed by amphiphilic space-charge electret material with high positive charge density through tearing off of the envelope protein and/or other key microbial proteins of the biohazard based on coupled effects of noncontact electrostatic interaction, contact electrification, and Van der Waals interactions. This new capture and disinfection mechanism mainly uses electrical charges (+/−) and their generated electrostatic field to create the physical barrier and disruption. As such, there is no need for additional energy or chemicals to stop the microorganisms or viruses from penetrating the surfaces. The cationic polymers selected for space-charge electret materials are also non-toxic. While this barrier can be applied and used in many ways, an example of how it may be used is application of the polymer to air filters. When properly performed, it will capture and trap the microorganisms and viruses, preventing them from passing through the filter into the post-filtered air.

### Space-Charge Electret Materials

The space-charge electret material of the present disclosure is comprised of one or more cationic polymers. Referring to FIG. 2, cationic polymers are a kind of macromolecules containing cationic groups, such as linear polyethylenimine (PEI or LPEI), polylysine (PLS), branched polyethylenimine (BPEI), chitosan (CS), cationic cellulose (CCL), polyamidoamine (PADAM), poly(amino-co-ester) s (PAE) and poly[2-(N, N-dimethylamine)ethyl methacrylate] (PDAMEMA). In some embodiments, the cationic polymer possesses primary, secondary or tertiary amine functional groups that can be protonated, such as (quaternary) ammonium salts, biguanidines, guanidines and pyridinium salts. In some embodiments, cationic polymers comprise non-amine cationic groups such as phosphonium salts and sulfonium. The cationic polymers can be natural, semi-synthetic, and synthetic and their polymer structures can be linear, branched, hyper-branched, or dendrimer-like. The placement of the cationic bearing groups can be either in the backbone or side chains. In some embodiments, the cationic polymer is gelatin, chitosan, cationic peptides, cationic cyclodextrin, or cationic dextran. In some embodiments, the cationic polymer is used for the fabrication of space-charge electret materials.

Different cationic polymers have different positive charge density. Other embodiments provide compositions having a high positive charge density surface of space-charge electret materials to meet the specific requirements of target applications. Positive charge density plays a key role in the degree of antibacterial and antiviral activity for a textile substrate treated with space-charge electret materials. In select preferred embodiments, the space-charge electret materials bonded to a hydrophobic substrate material, such as a textile, features a uniform or substantially uniform positive charge density across the surface area of the material. In some embodiments, the space-charge electret material has a positive charge density of 9.59 nC cm⁻². The disinfection effects increase with the increase of positive charge density. FIGS. 9-11 and 13 show that space-charge electret material with both high positive charge density and suitable hydrophobicity are found to have excellent antibacterial, antiviral, bactericidal and virucidal effects against Staphylococcus aureus, SARS-229E, SARS-COV-2 and Coxsackievirus B6 with an efficacy of over 98% in 5 minutes.

### Uses of Space-Charge Electret Materials

Space-charge electret materials can be applied and used in many ways for antibacterial, antiviral, bactericidal and virucidal applications. FIG. 3 illustrates the surface modification of textile substrate with space-charge electret materials for high positive charge density to obtain antiviral and antibacterial textiles. In preferred embodiments, the surface modification of the textile substrate with space-charge electret materials produces a uniform or substantially uniform (equal, constant, or substantially equal and/or constant) high positive charge density across the surface of the materials. The materials of textile substrates can be natural cotton, wool, cellulose, synthetic polyester, nylon and their blends. The structures of textile substrates can be knitted, woven and nonwoven. The blended textile substrates refer to the textile substrates woven or knitted with two or more different textile substrates. Their hydrophobicity or amphipathicity can be adjusted by blending. The textile substrates contain both hydrophilic fiber areas and hydrophobic fiber areas, but together show a general hydrophobic or hydrophilic performance. In other words, the blended textile substrates contain both hydrophilic fibers and hydrophobic fibers. When blending more hydrophobic fibers than hydrophilic fibers, the final surface wettability of 2D knitted/woven textile substrates shall be hydrophobic. The influence of fabric structures also play a key role, such as 3D spacer fabrics. Their surface wettability are mainly dependent on the surface layers. When the surface layers are knitted with 100% hydrophilic fibers, they are hydrophilic. Their surface wettability also can be adjusted to control the fiber compositions of surface layers like 2D fabrics. Based on materials and structures of used textile substrates, space-charge electret materials with antibacterial, antiviral, bactericidal and virucidal effects can be used for filter products with novel self-disinfection functions that can maintain high air-permeability and particle/bacteria/virus filtration efficacy, such as masks, protective garments and air purifiers. They also can be used for personal and home sanitation and hygiene items, such as hand sanitizers, moist towelettes, and toilet papers, home/hotel textiles, and related disposable items.

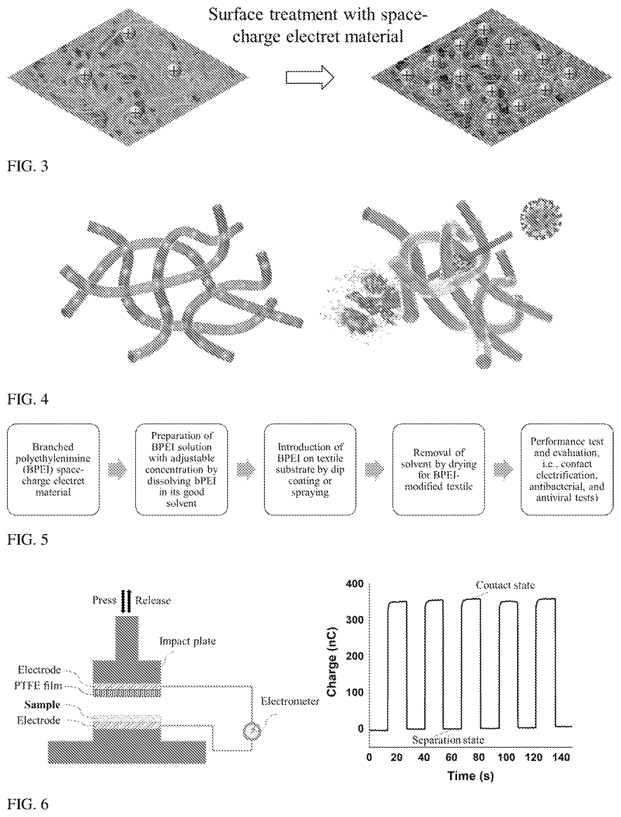

Referring to FIG. 4, the use of space-charge electret material for high-efficiency air filters with unique self-disinfection functions is exemplified and illustrated. The fibers of textile treated with amphiphilic space-charge electret materials are three-dimensionally conformably positively charged. When biohazards (such as bacteria and viruses) go through the textile, the fiber networks plays an intercept role and the highly positively charged fiber surface captures the biohazard with negative charges via noncontact electrostatic interaction/attraction. This strong electrostatic field makes the biohazard collide with the fiber surface to generate a sudden increase of electrical stress via contact electrification and be pinned on the positive charged fiber surface tightly. Finally, the biohazard is destroyed by the tearing/shearing off of its protein envelope and/or other key viral or microbial proteins of the biohazard, based on the coupled effects of noncontact electrostatic interaction, contact electrification, and Van der Waals forces interactions. Thus, air filters with unique self-disinfection functions can be developed by choosing suitable textile substrates for loading space-charge electret materials. These air filters of the present invention can capture bacteria and viruses, preventing them from passing through the filter into the filtered air, and can kill the bacteria and viruses to avoid contact infection.

### Methods of Making Antimicrobial Compositions

Referring to FIG. 5, a flowchart of the surface modification of a textile substrate materials with space-charge electret materials is exemplified based on using branched polyethylenimine (BPEI) as a single-component space-charge electret. Firstly, BPEI space-charge electret is dissolved in a suitable solvent to a desired concentration. Suitable solvents for BPEI include, but are not limited to, water, alcohol (such as ethanol) and their mixtures. BPEI can be dissolved in suitable solvents, such as water or ethanol, at any concentration. By way of example, a suitable solvent may be at least 10%, at least 20%, at least 30%, at least 40%, at least 50%, at least 60%, at least 70%, at least 80%, at least 90%, at least 95%, or 100% ethanol (or water). By alternate way of expression, the suitable solvent may be no more than 95%, no more than 90%, no more than 80%, no more than 70%, no more than 60%, no more than 50%, no more than 40%, no more than 30%, no more than 20% or no more than 10% of ethanol (or water). Combinations of any of these are also possible in some examples, e.g., a suitable solvent may be between 10 and 20%, 30 to 70%, or 50 to 95% ethanol. In some embodiments, the suitable solvent is water, including up to 100% water. In some embodiments, the BPEI concentration for surface modification of textile substrate material ranges from 1%-10%. By way of example, the BPEI concentration may be about 1%, about 2%, about 3%, about 4%, about 5%, about 6%, about 7%, about 8%, about 9% or about 10%. By way of further example, the BPEI concentration may be at least 1%, at least 2%, at least 3%, at least 4%, at least 5%, at least 6%, at least 7%, at least 8% or at least 9%. By alternate way of expression, the BPEI concentration may be no more than 10%, no more than 9%, no more than 8%, no more than 7%, no more than 6%, no more than 5%, no more than 4%, no more than 3% or no more than 2%. Combinations of any of these are also possible in select preferred embodiments, e.g., the BPEI concentration may be between 1-2%, 3-7%, or 5-9%. In other select embodiments, linear polyethylenimine is used as the space-charge electret material, including in respective correlative concentration to that of BPEI in preferred embodiments.

Secondly, BPEI is introduced on a desired textile substrate material by either dip coating or spraying. Preferred textile substrate materials involve cellulose and cellulose/polyester nonwoven fabrics. Thirdly, textile substrate loaded with BPEI solution is required for the removal of solvent, which can be conducted by drying in air or by drying at a high temperature for quicker solvent evaporation. Preferably, the drying temperature shall be not over 100° C. Finally, textile substrate materials modified with BPEI space-charge electret (BPEI modified textiles) can be used for systematic tests and evaluation, such as contact electrification performance evaluation, antiviral tests, antibacterial tests, virus filtration tests, and bacteria filtration test.

### Methods of Evaluating Contact Electrification Performance

FIG. 6 schematically illustrates the charge measurement device for evaluating the contact electrification performance of a space-charge electret material and its typical charge curves caused by repetitive contact and separation controlled by repetitively applying and releasing external force. Specifically, the method for measuring positive charge of a space-charge electret material is based on a double-layered device mainly consisting of a bottom acrylic plate fixed with an adhesive electrode layer and an upper acrylic plate fixed with an identically-sized reference material/electrode layer. In some embodiments, the adhesive electrode layers (and therefore the identically-sized reference material/electrode layer) are 6 cm×6 cm. In other embodiments, adhesive electrode layers having other dimensions and surface sizes are used. In some embodiments, PTFE film is fixed as a reference material. By way of example, other materials such as polydimethylsiloxane (PDMS) can be fixed as reference materials. Different reference materials give different measured (reference) values. PTFE possesses high electronegativity, and is particularly effective as a reference material to measure the positive charge performance of other testing samples. The testing samples can be woven/knitted/nonwoven fabric samples and films. The materials of textile/fabric substrates can be natural cotton, wool, cellulose, synthetic polyester, nylon, and/or blends thereof. The structures of textile/fabric substrates can be knitted, woven, and/or nonwoven. When testing, a sample (such as a nonwoven textile substrate surface modified with a space-charge electret material) is adhered to the adhesive electrode on the bottom acrylic plate smoothly and tightly. The upper acrylic plate can be controlled by machine to contact/impact the bottom acrylic plate repeatedly. This allows the contact of the surface of space-charge electret material-modified textile with PTFE surface by external pressure and enables their separation after the release of external pressure. An electrometer is connected to the electrodes for real-time monitoring and measurement of the charge variation. The stable charge curves measured by repetitive contact and separation are recorded for further analysis. Generally, a maximum charge value appears during the contact state, while a minimum charge value shows during the separation state. The value difference during the contact and separation states can be regarded as positive charges generated by contact electrification. The positive charge density is calculated by using positive charges divided with the effective contact area (e.g., 6 cm×6 cm), and can be used for quantitative evaluation of the degree of contact electrification. In other words, the charge density (σ) can be calculated by σ=Q/S, where Q is the total charge and S is surface area.

### Space-Charge Electret Material Concentrations & Charge Density of Textile Substrates

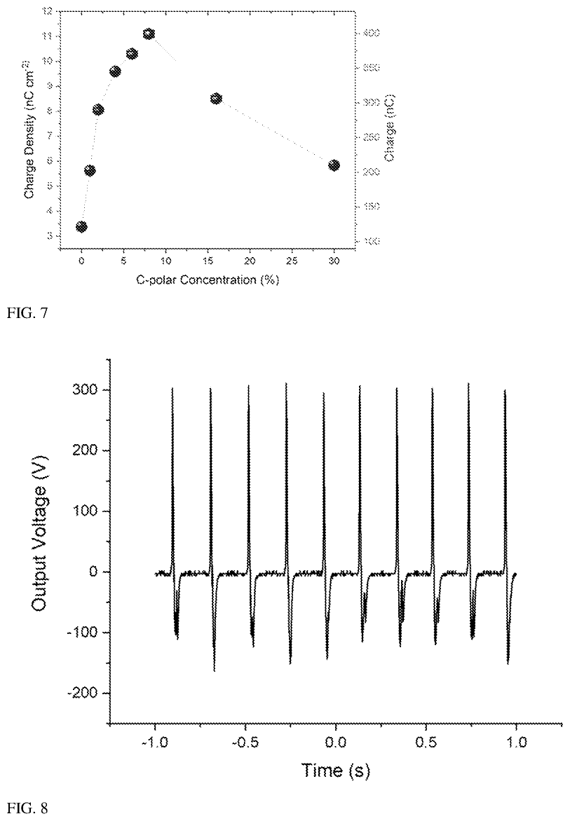

FIG. 7 shows the influence of single-component space-charge electret material (e.g., BPEI) concentration on the charge density of a textile substrate. A sample of 40 g spunlace (50% cotton/50% polyester) was used as textile substrate for introduction of a given amount of space-charge electret material. The aqueous solution concentration of BPEI space-charge electret for surface modification of the textile substrate ranged from 0-30 wt %. Referring to FIG. 7, when the C-polar (e.g., BPEI) concentration varies between 0% and 8 wt %, the charge density grows exponentially, owing to constructive interference over the spunlace surface. However, when the C-polar concentration is between 8 wt % and 30 wt %, the charge density drops significantly because overloading of C-polar destroys the texture and microstructure of spunlace and disrupts the constructive interference on polarity.

Different single-component space-charge electret materials have different positive charge density values. Some examples are shown in Table 1.

TABLE 1
The positive charge density of textile substrates treated with
various single-component space-charge electret materials.

| Space-charge electret material | Positive charge |
|---|---|
| used to treat textile substrates | density (nC cm⁻²) |
| 6 wt. % dimethyloctadecyl | 3.25 |
| [3-(trimethoxysilyl)propyl] | |
| ammonium chloride solution | |
| 6 wt. % cationic cellulose | 9.91 |
| 6 wt. % didecyldimethylammonium chloride | 0.37 |

Therefore, the positive charge density of textile substrates can be adjusted by adjusting the solution concentration and components of space-charge electret materials.

To obtain modified textiles with high positive charge density, single-component space-charge electret materials with high charge density and suitable concentration can be selected. To obtain modified textiles with suitable positive charge density and hydrophobicity, multiple-component space-charge electret materials can be selected based on different types of cationic polymers and components. The selection of cationic polymers with higher hydrophobicity can use polymers with low density cationic groups and long alkyl chains. In select preferred embodiments of the invention, the high positive charge density of the modified textiles is uniformly or substantially uniformly applied and obtained across the surface area of the textile.

FIG. 8 shows the instantaneous output voltage generated when textile surface modified with high positive charge density space-charge electret material was contacted/impacted repeatedly. This result demonstrates the drastic change of electrostatic potential during contact electrification.

### Antiviral Efficacy

Referring to FIG. 9, the antiviral activity testing for the textile substrate treated with a space-charge electret material (i.e., BPEI spunlace) against SARS-COV-2 was adopted from ISO 18184. Firstly, 50 μl of SARS-COV-2 (100,000 PFU/ml) was added to 1×1 cm² of the textile substrate material treated with the space-charge electret material and a control in triplicate. The test textile substrates were incubated for 5 minutes or 30 minutes at room temperature covered with glass. After incubation, the test textile substrates were transferred into 5 ml of DMEM complete media, vortexed 5 times for 5 seconds and 200 μl of the media were transferred on VERO-E6 cells and titers of remaining virus were determined by plaque assay. Virus with cells (250,000 cells/well) in a 24-well plate were gently mixed and incubated for 4 hours at 37° C. in a CO₂ incubator. After that, 0.4 ml of 3% carboxymethylcellulose was added and then incubated for 5 days. After incubation, the cells were washed, stained with Naphthol blue black dye, rinsed with water and dried to count plaques. The titers were expressed as pfu/ml and virus yield reduction was expressed in percentage, as shown in FIG. 9. The virucidal performance of different textile substrates (e.g., cellulose and cellulose/polyester substrates) treated with different solution concentrations of C-Polar (BPEI) (i.e., 4%, 6% or 8% BPEI space-charge electret material) were summarized. Briefly, cellulose/polyester textile treated with BPEI showed overall better virucidal potency than cellulose textile treated with BPEI. Cellulose/polyester textile treated with 6% BPEI space-charge electret material eliminated 98% of SARS-COV-2 after 5 minutes exposure and 99.6% of SARS-COV-2 after 30 minutes exposure, respectively. 100% virus elimination was achieved in one of the biological replicate studies. The reason can be ascribed to the synergistic effects of high positive charge density and suitable lipophilicity (i.e., hydrophobicity) of BPEI-modified fabrics. Owing to the hydrophobic component of polyester, cellulose/polyester blended textiles generally show higher hydrophobicity than single-component cellulose textile. As stated above, the hydrophobicity of amphiphilic material also plays an important role in inserting its lipophilic partition into the membrane via Van der Waals interactions. This lipophilic property contributes to enhancing the electric stress generated by strong electrostatic field to tear off the envelope protein of the biohazard and/or other key viral or microbial proteins of the biohazard (Referring to FIG. 1 and paragraph [0085]). A suitable increase of BPEI can obviously increase the positive charge density, but can also increase the hydrophilicity of textile substrates. An excessive increase of BPEI results in embedding the hydrophobic surface of textiles and decreasing the lipophilicity, thereby slightly decreasing the virucidal potency.

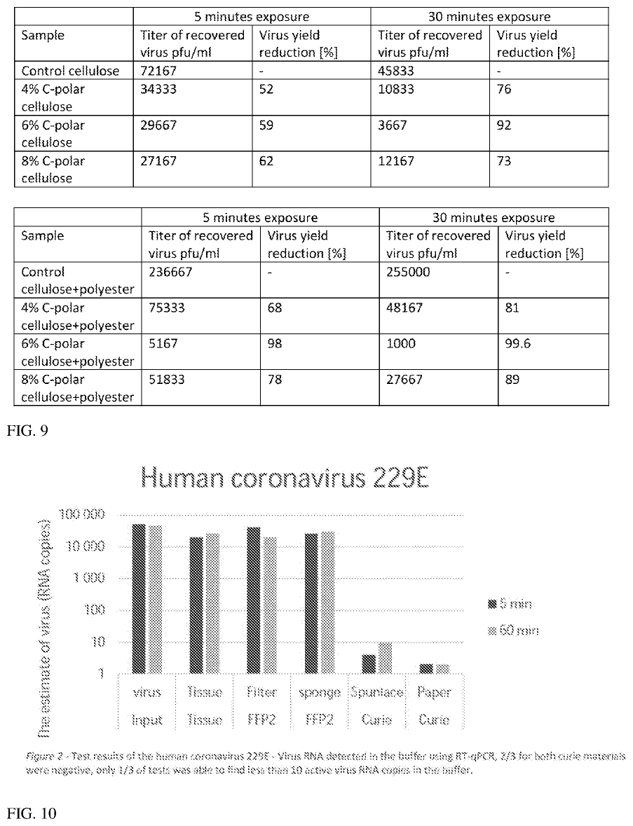

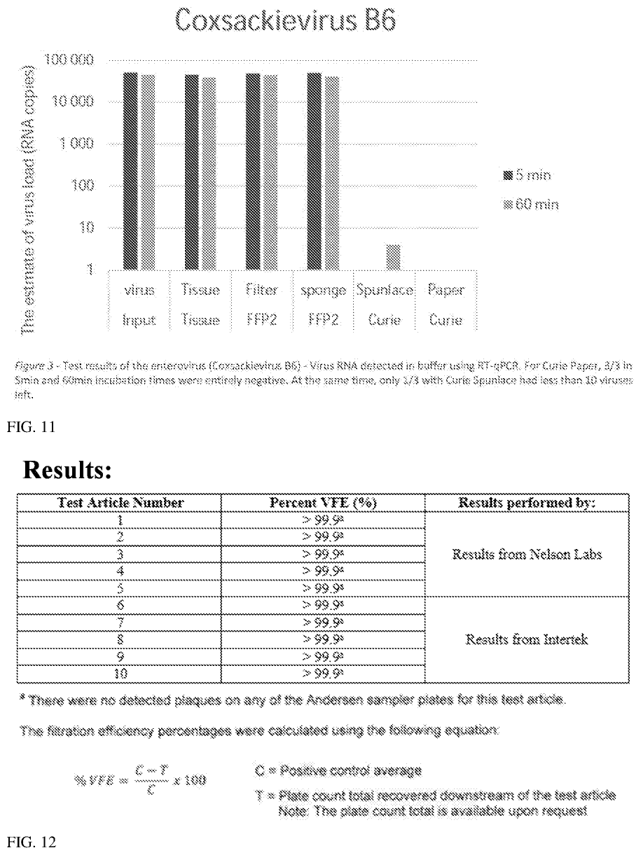

Referring to FIGS. 10 and 11, the antiviral activity testing for the textile substrate treated with the space-charge electret material (e.g., 4% BPEI spunlace or 4% C-POLAR spunlace) against human coronavirus 229E and Coxsackievirus B6 was performed. Firstly, 2.5×2.5 cm pieces of the test textile materials were soaked in 200 μl of buffer with virus (50000 PFU) and incubated at room temperature for 5 minutes or 60 minutes, respectively. Then the tubes containing the test textile materials and the buffer were centrifuged. After the test textile materials were removed from the buffer, the virus concentrations of the buffer were tested using RT-qPCR. The test results of different textile materials for killing human coronavirus 229E and Coxsackievirus B6 were shown. The textile materials used included tissue (100% cellulose), FFP2 filter (non-woven polyester), FFP2 sponge (non-woven), Curie spunlace (i.e., cellulose/polyester textile treated with 4% BPEI space-charge electret material) and Curie paper (i.e., cellulose treated with 4% BPEI space-charge electret material). Both cellulose textile and cellulose/polyester treated with BPEI showed surprisingly better virucidal performance than those textiles without BPEI space-charge electret materials (such as tissue, FFP2 filter, and FFP2 sponge). Most surprisingly, the results demonstrated that the textile substrate treated with BPEI were 10,000 times more efficacious on antiviral activity than conventional filtration media were. In addition, the fact that similar effects were obtained for two viruses that have different structural aspects (enterovirus and coronavirus) demonstrate that the BPEI space-charge electret materials on both polyester/cellulose and cellulose textile substrates work well in the elimination of different types of viruses. These two viruses represented enveloped (coronavirus with lipid bilayer structure) and nonenveloped (enterovirus with capsid structure) viruses which means that their surface structures are very different. In addition, the observed 99.9% reduction of the viruses in the buffer was seen already, even after the briefest incubation time tested (5 minutes), suggesting a rapid effect of the polyester/cotton and the cellulose materials on the viruses, which is a critical core feature for the mask material's functionality and suggests a high efficacy to segregate viruses.

Referring to FIG. 12, the viral filtration efficacy testing was adapted from ASTM F2101, US FDA Good Manufacturing Practice (GMP) regulations 21 CFR Parts 210, 211 and 820. The viral filtration efficiency (VFE) of the test articles was determined by comparing the viral control counts upstream of the textile substrate treated with the space-charge electret material (e.g., 2%-9% BPEI spunlace or C-POLAR spunlace comprising non-woven fibers) to the counts downstream. Five test articles were tested by the Nelson Labs and another five test articles were tested by the testing lab Intertek. Briefly, a suspension of bacteriophage ϕX174 was aerosolized using a nebulizer and delivered to the textile substrate material treated with the space-charge electret material at a constant flow rate and fixed air pressure. The challenge delivery was maintained at 1100-3300 plaque forming units (PFU) with a mean particle size (MPS) of 3.0±0.3 μm. The test area was about 40 cm². The VFE flow rate was 28.3 liters per minute (L/min) in 85±5% relative humidity and 21±5° C. for a minimum duration of 4 hours. The positive control average was 1.6×10³ PFU and the negative monitor count was <1 PFU. The aerosol droplets were drawn through a six-stage, viable particle Anderson sampler for collection. The results showed that the textile substrates treated with space-charge electret materials are efficacious in keeping the viruses from penetrating through the textile filters. Cellulose/polyester textiles treated with BPEI space-charge electret material were demonstrated to have a viral filtration efficacy of over 99.9%. There were no detected plaques on any of the Andersen sampler plates.

### Antibacterial Efficacy

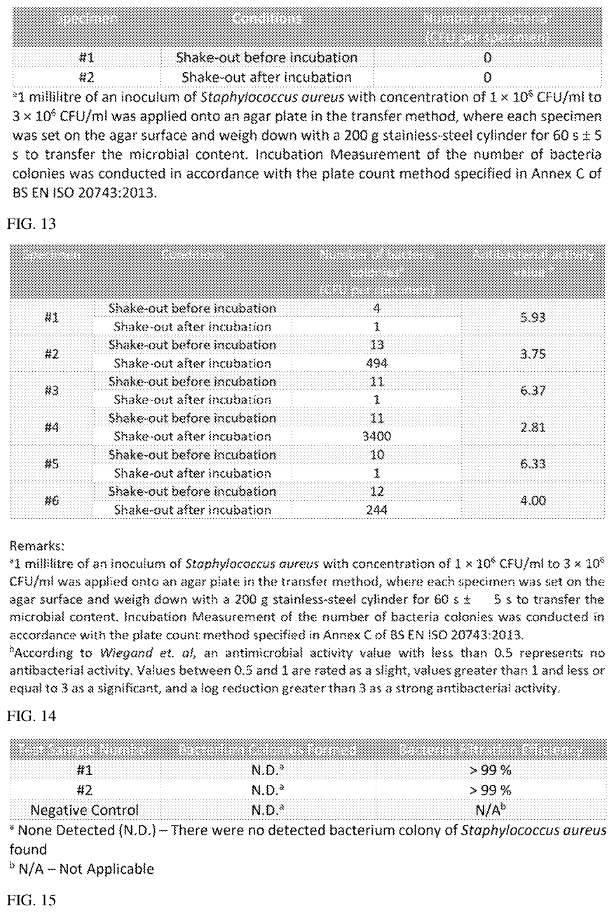

Referring to FIGS. 13 and 14, antibacterial activity testing for a textile substrate treated with space-charge electret material (2%-9% BPEI spunlace) was performed. Briefly, the textile substrates treated with space-charge electret material were washed by washing machine with cold water and washing powder 60 times. 1 milliliter of an inoculum of Staphylococcus aureus at concentration of 1×10⁶ CFU/ml to 3×10⁶ CFU/ml was applied to an agar plate in the transfer method, where each textile substrate treated with space-charge electret material was set on the agar surface and weighed down with a 200 g stainless-steel cylinder for 60 seconds±5 seconds to transfer the microbial content. Measurement of the number of bacteria colonies was conducted in accordance with the plate count method specified in the Annex C of BS EN ISO 20743:2013. The test results for different textile substrates treated with BPEI space-charge electret material without washing, before washing, and after 60 washing, for killing Staphylococcus aureus were summarized. In accordance with the methods of Wiegand C., Heinze T. and Hipler U. C. (2009), Comparative in vitro study on cytotoxicity, antimicrobial activity, and binding capacity for pathophysiological factors in chronic wounds of alginate and silver-containing alginate. Wound Repair Regen., 17, 511-521, an antimicrobial activity value with less than 0.5 is determined to represent no antibacterial activity. Values between 0.5 and 1 are rated as slight activity, values greater than 1 and less or equal to 3 are rated as significant activity, and a log reduction greater than 3 represents strong antibacterial activity.

TABLE 2
Material of the textile substrate for each sample no. in FIG. 13.

| Sample no. shown | Material of Textile | Space-charge |
|---|---|---|
| in FIG. 13 | Substrate | electret material |
| #1 | 50% cotton/50% polyester | 2%-9% BPEI |
| #2 | 50% cotton/50% polyester | 2%-9% BPEI |

TABLE 3
Material of the textile substrate for each sample no. in FIG. 14.

| Sample no. | Material of Textile | Space-charge |
|---|---|---|
| shown in FIG. 14 | Substrate | electret material |
| #1 | 100% cotton plain | 2%-9% BPEI |
| #2 | 100% cotton after 60 washes | 2%-9% BPEI |
| #3 | polyester/cotton (65%/35%) | 2%-9% BPEI |
| #4 | polyester/cotton (65%/35%) | 2%-9% BPEI |
| | after 60 washes | |
| #5 | polyester/spandex (92%/8%) | 2%-9% BPEI |
| #6 | polyester/spandex (92%/8%) | 2%-9% BPEI |
| | after 60 washes | |

Taken together, the results show that both 50% cotton/50% polyester and 35% cellulose/65% polyester textile treated with BPEI space-charge electret material killed Staphylococcus aureus with efficacy of over 99.9%. The antibacterial activity values of textile substrates after washing 60 times are greater than 3, indicating that 60 washes have little influences on the strong antibacterial activity of BPEI-treated cellulose/polyester textile material.

Referring to FIG. 15, the efficaciousness of the space-charge electret material treated filter to stop the bacteria from penetrating through the filter during fast air flow was evaluated. The bacterial filtration efficiency testing was adapted from ASTM F2101:2019. The bacterial filtration efficiency (BFE) of test articles was determined by comparing the bacterial control counts upstream of the textile substrate treated with the space-charge electret material (2%-9% BPEI spunlace comprising 50% cotton/50% polyester) to the counts downstream. Briefly, a suspension of Staphylococcus aureus in peptone water was aerosolized using a nebulizer and delivered to the textile substrate treated with the space-charge electret material at a constant flow rate and fixed air pressure at 21±5° C. and relative humidity of 65±5% for a minimum of 4 hours. The challenge delivery was maintained at 2200 colony forming units (CFU) with a mean particle size (MPS) of 3.0±0.3 μm. The aerosol droplets were drawn through a tryptic soy agar plate for collection under vacuum (flow rate: 100 liters per minute). After having incubated at 37±2° C. for 48±4 hours, the number of Staphylococcus aureus colonies formed on the tryptic soy agar plate were counted. The results showed that the 50% cotton/50% polyester textile treated with BPEI space-charge electret material achieved a bacterial filtration efficacy of over 99.9%. There were no detected bacteria colonies of Staphylococcus aureus found. These results demonstrate that the cotton/polyester textile treated with BPEI space-charge electret material stopped all penetration of bacteria from penetrating through the filter when using fast air flow.

### Cytotoxicity

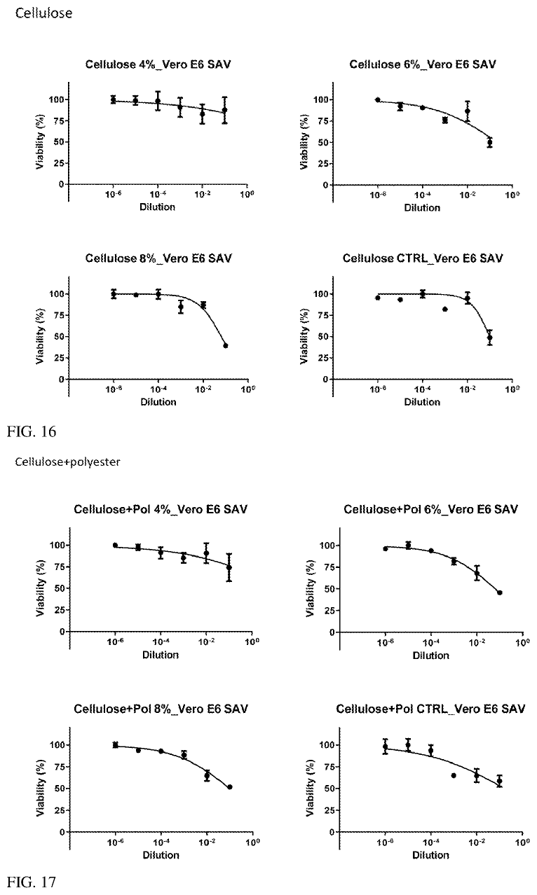

Referring to FIGS. 16 and 17, the influences of cellulose textile and cellulose/polyester textile treated with different solution concentrations of BPEI space-charge electret material on the viability of VERO E6 cells were investigated, respectively. Briefly, 1×1 cm² of textile substrates treated with the 4%, 6% or 8% of BPEI space-charge electret materials (C-POLAR) were incubated in 10 ml of DMEM complete media for 30 minutes. After the incubation, the media were transferred to the VERO E6 cells in 96-well plate in triplicate with 10-fold dilutions and incubated at 37° C., 5% CO₂ for 72 hours. The cell viability was determined by addition of XTT solution for 4 hours and the absorbance of newly formed orange formazan solution was measured using EnVision plate reader. The absorbance was normalized to no sample control set to 100% and plotted versus log₁₀ dilution in GraphPad software. The results show that the wash-out from control textiles and space-charge electret material treated textiles moderately reduced VERO E6 cell proliferation. There was no difference in VERO E6 cell proliferation between untreated and C-polar treated textiles for the 3 days of incubation.

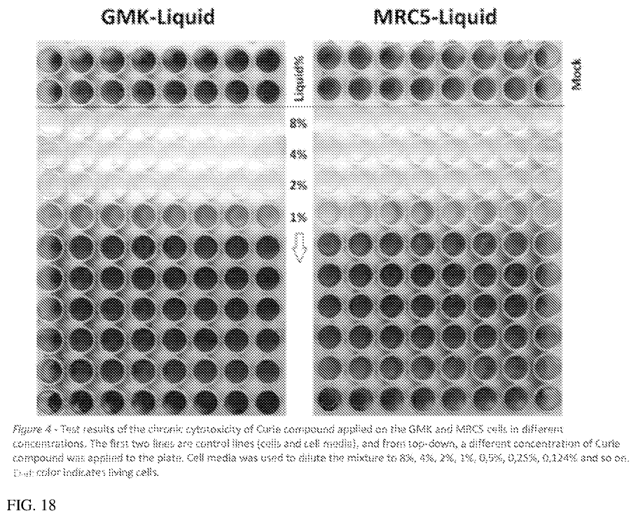

Referring to FIG. 18, the cytotoxicity of different concentrations of BPEI space-charge electret materials (C-POLAR) on GMK (Green Monkey Kidney) cells and MRC5 (Medical Research Council cell strain 5, originated from human lung tissue) cells was investigated. Cell culture media were used to dilute the liquid formulation of BPEI space-charge electret materials to 8%, 4%, 2%, 1%, 0.5%, 0.25%, 0.124% and so on. The diluted BPEI space-charge electret materials were transferred into a culture plate and equal volumes of cells suspended in full media were then added into each well, replicated in 8 paralleling wells in a 96-well plate. The cells were incubated at 37° C. for 5 days until the bottom of the plate in each well became covered with cells. Cells were fixed and stained at the end of Day 5 to visualize the viable and replicating cells. The results demonstrated that 0.5% of the BPEI space-charge electret material remained comparable to control for 5 days of incubation. It also demonstrated that if 8.3% of the total polymer over the textile substrates treated with the BPEI space-charge electret material wore off, no significant cytotoxicity on GMK cells and MRC5 cells occurred.

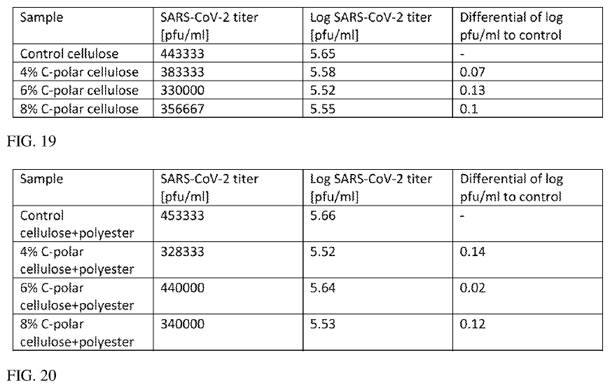

Referring to FIGS. 19 and 20, the influence of cellulose textile and cellulose/polyester treated with different solution concentrations of BPEI space-charge electret materials on the cell sensitivity were investigated. Briefly, the 1×1 cm² of textile substrates treated with the 4%, 6% or 8% of BPEI space-charge electret material were washed in 10 ml DMEM complete media by vortexing for 5 times for 5 seconds. 5 ml of the media was transferred to another tube and 50 μl of SARS-COV-2 (100,000 IU/mL) was added and the mixture was incubated for 30 minutes at room temperature. After the incubation, 200 μl of the mixture was removed and titered by plaque assay in a 24-well plate in DMEM complete medium using 10-fold dilution. Virus with cells (250 000/well) was gently mixed and incubated for 4 hours at 37° C. After that, 0.4 ml of 3% carboxymethylcellulose was added and then the plates were incubated for 5 days. After incubation, cells were washed, stained with Naphthol blue black dye, washed with water and dried. Plaques were counted as pfu/ml, expressed in log₁₀, compared to log₁₀ pfu/ml of untreated control and log₁₀ differentials in virus titer were determined. The results showed that no cell sensitivity reduction was found.

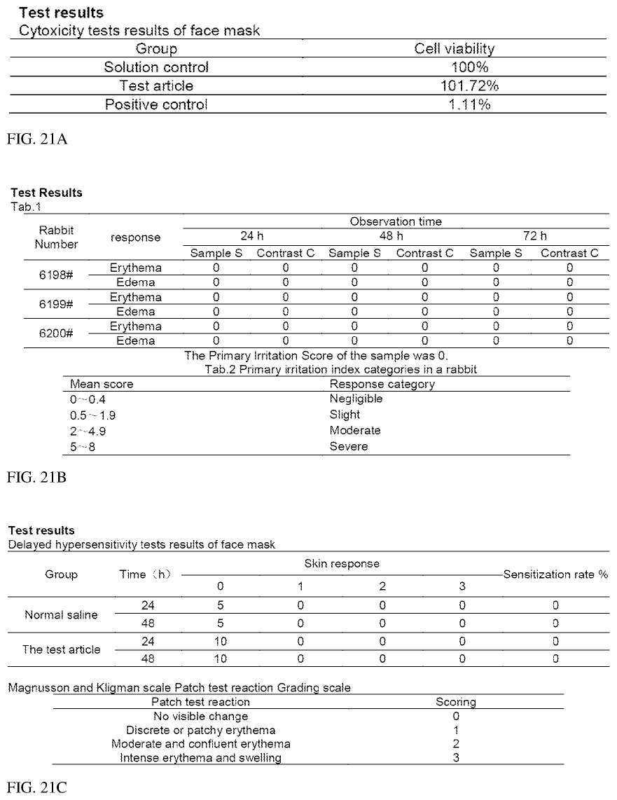

Referring to FIGS. 21A-21C, the tests of ISO 10993-5 (Tests for in vitro cytotoxicity), ISO 10993-10 (Animal skin irritant tests) and ISO 10993-10 (Skin sensitization tests) on the textile substrates treated with the 2%-9% BPEI space-charge electret material were performed to determine biocompatibility of the treated textile substrates. For the tests for in vitro cytotoxicity, the treated textile substrates were sterilized at 121° C. for 30 minutes and were extracted with 1640 medium in ratio of 3 cm²/ml in 37° C. for 24 hours. The positive control was polyurethane film containing 0.1% zinc diethyl-dithiocarbamate (ZDEC). Mouse fibroblast cells L929 were cultured in RPMI 1640 medium supplemented with L-glutamine, 10% FBS and penicillin-streptomycin at 37° C. 5.0% CO₂. The L929 cells were seeded in 96-well plates and to each well was added 100 μl of cell solution with a density of 1×10⁵ cells/ml. The L929 cells were treated with the extracted media of the treated textile substrates and 6 replicate wells were used. After 24-hour treatment, 50 μl of MTT solution was added to each well. After incubation, washing and isopropanol extraction, the absorbance of each well was detected at 570 nm with a spectrophotometer and cell viability was calculated. The results in FIG. 21A showed that the cytotoxicity of the textile substrate treated with the BPEI space-charge electret material was grade 0, which is deemed non-cytotoxic.

For the animal skin irritant tests, four healthy conventional New Zealand White Rabbits, female, 2.0-3.0 kg each were employed. The rabbits were kept at room temperature (18-23° C.) in relative humidity of 45-65%. The results in FIG. 21B showed that the textile substrate treated with the 2%-9% BPEI space-charge electret material was found to be a negligible irritant to rabbit skin, according to primary irritation index categories in a rabbit.

For the skin sensitization tests, guinea pigs, female, 300-500 g each were employed. The guinea pigs were kept at room temperature (20-22° C.) in relative humidity of 45-65%. The results in FIG. 21C showed that the textile substrate treated with the BPEI space-charge electret material did not cause delayed dermal contact sensitization in the guinea pigs. Taken together, the textile substrate treated with the BPEI space-charge electret material is revealed to be a biocompatible material.

### Process of Loading Space-Charge Electret Materials on Textile Substrate

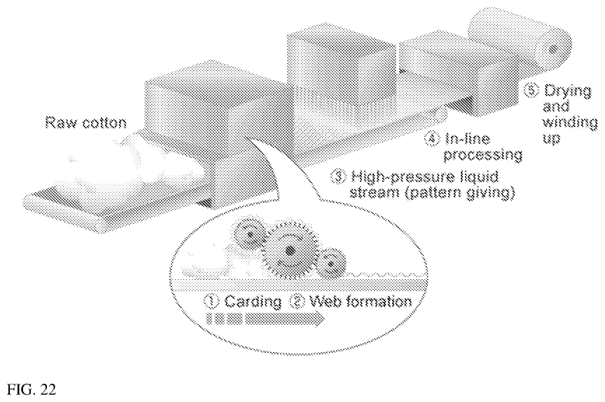

Referring to FIG. 22, a process of loading space-charge electret material on the textile substrate's surface is shown. The textile substrate is formed as a drylaid web by carding. As exemplary embodiments, the textile substrate can be natural cotton, wool, cellulose, synthetic polyester, nylon and/or their blends. The space-charge electret material is loaded on a fabric surface of the drylaid web by high-pressure liquid stream to form a nonwoven fabric. A special in-line processing is performed. Then the space-charge electret material forms crosslinkers with the fabric surface to form the textile substrate's surface by drying under high temperature and winding up.

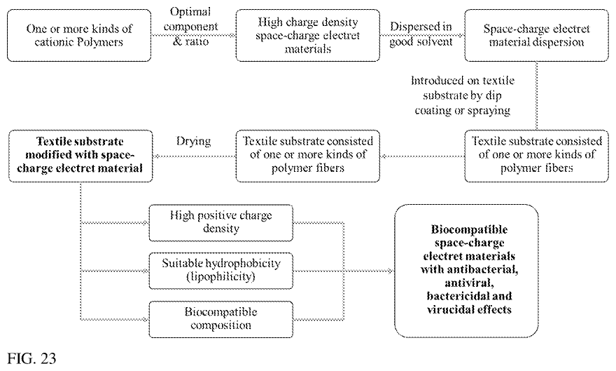

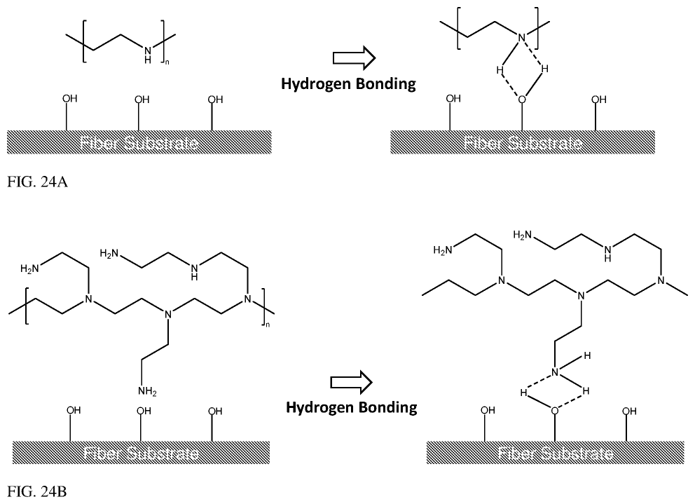

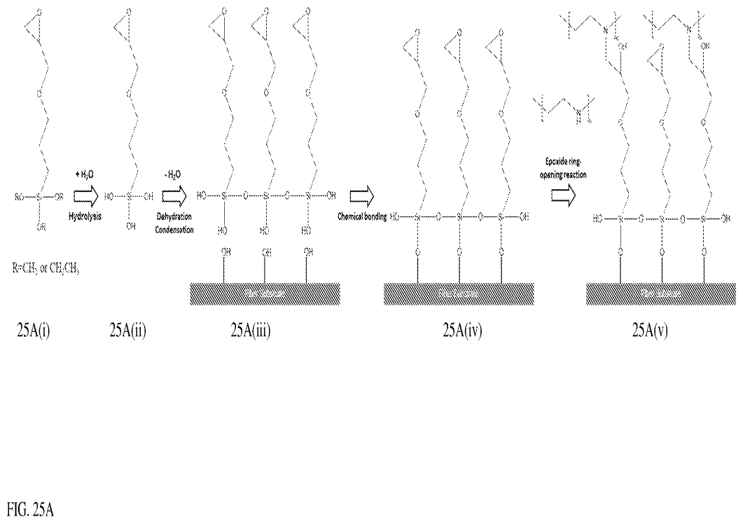

Referring to FIG. 23, a flowchart of design and fabrication of biocompatible space-charge electret materials with high charge density based on cationic polymers and textile substrates for antibacterial, antiviral, bactericidal and virucidal applications is given. One or more kinds of cationic polymers with different positive charge density and surface wettability (hydrophilicity and/or hydrophobicity) can be selected for design and fabrication of high charge density space-charge electret materials with suitable hydrophobicity to meet the specific requirements of target applications. The hydrophilicity of space-charge electret materials can be adjusted by the types and density of cationic bearing groups, while the hydrophobicity can be adjusted by the length of hydrophobic alkyl chains and hydrophobic groups. They can be dissolved in their suitable solvents for the preparation of homogeneous dispersion to modify the textile substrates by the combination of dip coating/spraying and drying. To achieve good antibacterial, antiviral, bactericidal and virucidal effects, the positive charge density of space-charge electret material shall be at least 9.59 nC cm⁻². In preferred embodiments, the positive charge density of space-charge electret material is uniform or substantially uniform (constant) across the surface area of the electret material. In some embodiments, the textile substrates consist of hydrophobic fibers. To achieve biocompatible performance, the composition (such as component and component ratio) shall be controlled to be nontoxic.

### Processes for Preparing Bonded Compositions

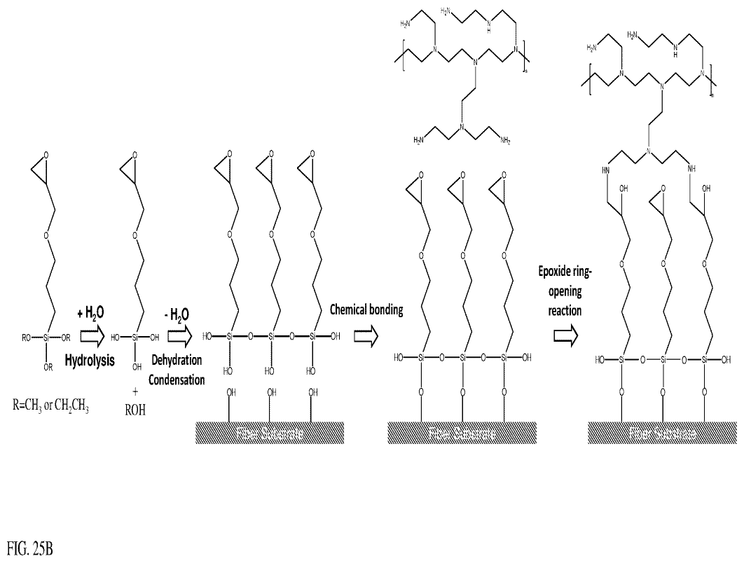

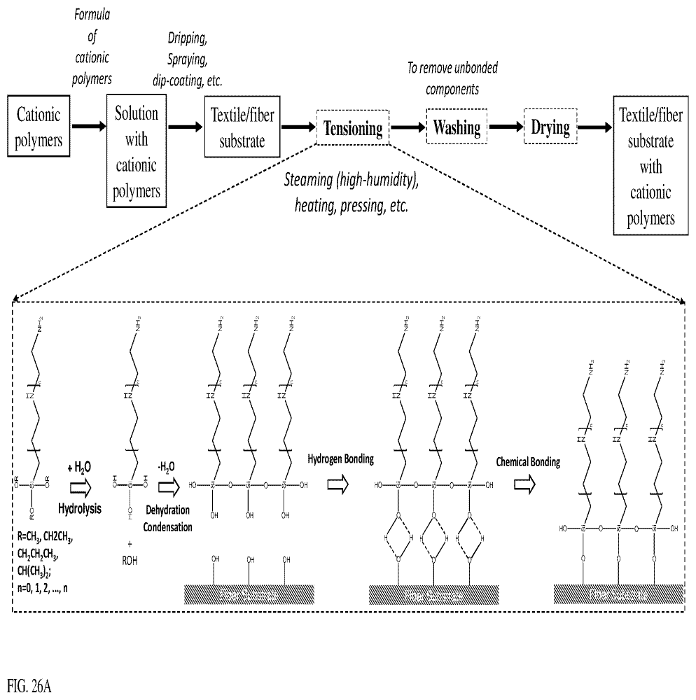

FIG. 24A-24B illustrate a process for preparing linker compositions of the present disclosure where linear or branched PEI is hydrogen bonded with a fiber substrate (an example of a hydrophobic material). Such hydrogen bonding is achieved by first dissolving a certain amount of linear or branched PEI in water at 20° C. to form 6% by weight solution of PEI in water. This is followed by dip coating the fiber substrate into the resultant PEI solution and/or spraying the resultant solution onto the fiber substrate. In some preferred embodiments, the fiber substrate is dipped in the PEI solution for 2-10 seconds. Finally, the dipped fiber substrate is air dried, optionally with heat, preferably at a heat of 50° C.-160° C. for at least 5 seconds, and/or optionally undergoes a tensioning process, which may include one or more of the actions of stretching, steaming, heating, pressing, and/or subjecting the coated fiber substrate to pressure, including high airflow pressure or mechanical pressure. The resultant PEI coated fiber substrate is confirmed by measuring the variation of grammage (grams per square meter), wherein a limited variation tolerance is considered acceptable.

In most preferred embodiments of the invention, a tensioning process step is applied to subject coated fiber substrate materials, wherein a “tensioning process” includes one or more of the acts of stretching, steaming, heating, pressing, or subjecting the material to pressure, including high airflow pressure or mechanical pressure. For example, a fiber substrate material can be drawn into a heating chamber with rollers and dried at a higher temperature, e.g., 160° C. It shall be understood that the force applied on the textile substrate material may be adjusted by the rollers. Furthermore, the drying time and temperature may also be adjusted. In some exemplary embodiments, the temperature is 100° C.-200° C., 150° C.-200° C., 150° C.-175° C., 175° C.-200° C., 150° C.-170° C., or 155° C.-165° C. In a most preferred embodiment, the temperature is 160° C.

The resultant PEI coated fiber substrate material may be confirmed by measuring the variation of grammage (grams per square meter), wherein a variation of 10% is considered acceptable.

The mass variation of PEI modified textile can be calculated by W=(m₁−m₀/m₀*100%, wherein m₁ is the grammage of PEI modified textile substrate material and m₀ is the grammage of the pristine textile substrate material.

### Branched PEI: Select Exemplary Embodiment 1

In an exemplary embodiment, 60 g of branched PEI polymers (MW 20000) is dissolved in 940 ml of water at room temperature and stirred for at least 5 minutes to form a 6% branched PEI solution. A 0.30 mm thick 50% polyester 50% cotton cellulose fabric material is dipped in the 6% branched PEI solution for 2-10 seconds, or by spraying the fabric material with a shower spray within a shower chamber. Once fully wet, the fabric material undergoes a tensioning process wherein the PEI coated fabric is drawn into a heating chamber with rollers and is dried at 160° C. for at least 5-20 seconds. “Tensioning” may also include one or more actions of stretching, steaming, heating, pressing, and/or subjecting the material to pressure, including high airflow pressure or mechanical pressure. The resultant coated fabric material is characterized by grammage measurement and FT-IR attenuated total reflectance (ATR) spectroscopy. Anti-microbial properties may be confirmed via tests described herein.

### Branched PEI: Select Exemplary Embodiment II

In another exemplary embodiment, 40 g of branched PEI polymers (MW 25000) are dissolved in 960 ml of water at room temperature and stirred for at least 5 minutes to form a 6% branched PEI solution. A 0.30 mm thick 50% polyester/50% cotton cellulose fabric material is dipped in the 6% branched PEI solution, and then dried at 160° C. for 10 seconds. The resultant coated fabric material is characterized by grammage measurement and FT-IR attenuated total reflectance (ATR) spectroscopy.

The grammage of pristine 50% polyester/50% cotton cellulose fabric material is 35-75 g/m². BPEI modified 50% polyester/50% cotton cellulose fabric material treated with 1%-6% BPEI solution according to the above-disclosed example has a mass variation W of between 10% and 70%.

### Linear PEI: Select Exemplary Embodiment

In another preferred embodiment, 500 mg of linear PEI polymers are dissolved in 500 ml of water to form a homogeneous and clear solution. A 0.30 mm thick 50% polyester/50% cotton cellulose fabric material is used as substrate and soaked in linear PEI solution for 5 minutes and then taken out for air drying. In a most preferred embodiment, when the wet substrate no longer drips liquid under gravity conditions, it is transferred to an oven at 60° C. for expedited drying. The dried substrate is ironed at 160° C. on both sides. Finally, it is dried at 60° C. to obtain the linear PEI modified 50% polyester/50% cotton cellulose fabric material. The resultant coated fabric is characterized by grammage measurement and FT-IR attenuated total reflectance (ATR) spectroscopy.

The antimicrobial properties of the PEI and BPEI modified fabric may be confirmed via tests described herein.

### Process for Preparing Si-Linker Compositions

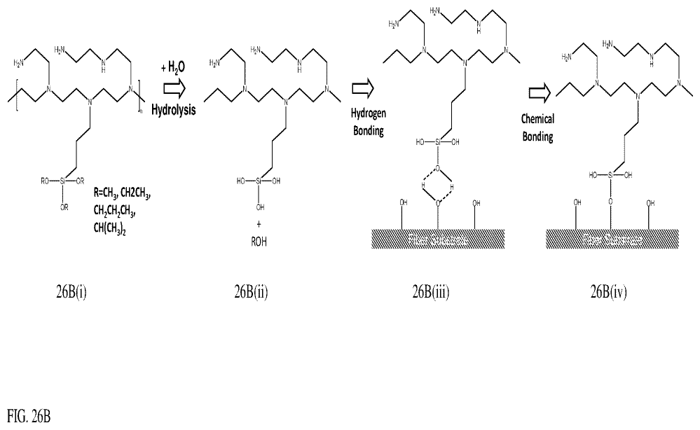

FIG. 25A-25B illustrate one way in which silyl-linkers having an epoxide group are first bonded to the fiber substrate (hydrophobic material) and to each other via single-O-linkers; and then combined with linear or branched PEI via an epoxide ring-opening reaction.

In an exemplary embodiment, 10 g of 3-glycidyloxypropyltrimethoxysilane (FIG. 25A (i)) is dissolved in 1000 mL of acetic acid/water solution at room temperature. The pH of the aqueous solution is adjusted to 5.3 by the addition of acetic acid. The methoxyl groups react with water via hydrolysis to form a 1% silane aqueous solution of the compound of FIG. 25A (ii). Then a fiber substrate, such as 0.30 mm thick 50% polyester 50% cellulose material, is soaked in the 1% silane aqueous solution. The solution is heated to 40° C. and held for 2 h. resulting in the compounds of formula 25A (iii), wherein the at least some silyl-linkers bind to each other via single-O-linkers. This reaction also leads to binding the compounds of formula 25A (iii) with fiber substrate via-O-linkers to form a compound of formula 25A (iv). The modified fiber substrate 25A (iv) is taken out of the solution for “draining water in the air,” meaning a portion of the excess water is removed by physical means, such as draining or gravity drip in air. In a most preferred embodiment, the modified fiber substrate 25A (iv) is then transferred to an oven for further heated drying at 60° C. for 2 hours. After water has been completely removed (i.e., the modified fiber substrate 25A (iv) is complete dry), the dried modified fiber substrate 25A (iv) is further washed with pure water to remove any remaining starting materials, unreacted compounds, and acetic acid. The washed modified fiber substrate 25A (iv) is re-dried at 60° C. for 2 hours. After drying, the modified fiber substrate 25A (iv) is dipped in a linear PEI solution doped with lithium perchlorate and further tensioned at 160° C. for at least 10 seconds such that the PEI polymers and the linkers are bonded via epoxide ring-opening to form the compounds of formula 25A (v). The linear PEI modified fiber substrate of formula 25(A) (v) is transferred to an oven and heated at 60° C. for 2 hours. Finally, the compound of formula 25(A) (v) is washed with pure water to remove and unreacted or unbonded polymers and catalyst, and re-dried at 60° C. for 2 hours. Branched PEI is also chemically bonded with the fiber substrate by the same procedure, as shown in FIG. 25B.

FIG. 26A illustrates process steps for bonding a cationic polymer of the present disclosure with textile/fiber substrate. First, a cationic polymer solution is prepared by dissolving one or more cationic polymers in a suitable solvent. Next, a textile/fiber substrate is coated with the cationic polymer solution by dripping, spraying, dip-coating, or other methods known to one skilled in the art. In select preferred embodiments, the substrate is coated with the cationic polymer in a manner such that the coating, and resulting positive charge density, is uniform or substantially uniform across the surface area of the textile/fiber substrate. Next, the textile/fiber substrate coated with the one or more cationic polymers undergoes tensioning. “Tensioning” includes one or more of stretching, steaming, heating, pressing, and subjecting to pressure, including high airflow pressure or mechanical pressure, during and/or after which the one or more cationic polymers are hydrolyzed and then dehydrated, wherein the certain silyl-hydroxyl groups may optionally condensated with each other. By way of example, the cationic polymers with silyl-linkers bind to each other via single-O-linkers. After that, the dehydrated/condensed cationic polymers form hydrogen bonding with the textile/fiber substrate, followed by the formation of chemical bonding between the hydroxyl groups of the dehydrated/condensed cationic polymers and the textile/fiber substrate. After the tensioning, the mixture is washed to remove unbonded components, and then dried to obtain textile/fiber substrate with cationic polymers.

FIG. 26B shows an example schematic of how a branched cationic polymer bonds with a fiber substrate. Branched cationic polymer with silyl-linker(s) 26B (i) is dissolved in water under hydrolysis conditions to form a branched cationic polymer with silyl-linker(s) 26B (ii) solution. A fiber substrate is then soaked in a 6% solution of the branched cationic polymer with silyl-linker(s) 26B (ii) at 40° C. for 2 hours, to first form the branched PEI-linked fiber substrate 26B (iii) and then the antimicrobial composition of formula 26B (iv). The modified fiber substrate, which contains a mixture of compounds of formula 26B (iii) and formula 26B (iv), is taken out of the solution, drained in the air, and then transferred to an oven and heated at 60° C. for 2 hours to form the compound of formula 26B (iv). After complete drying, modified fiber substrate of formula 26B (iv) is washed with pure water to remove excess or unreacted compounds and re-dried at 60° C. for 2 hours to obtain the textile/fiber substrate with surface modification of branched PEI, an antimicrobial composition of formula 26B (iv).

In an exemplary embodiment, 20 g of 3-[2-(2-Aminoethylamino)ethylamino]propyl-trimethoxysilane is dissolved in 1000 mL water solution at room temperature to form a 2% silane solution. Then a fiber substrate, such as 0.30 mm thick 50% polyester 50% cellulose material, is soaked in the 2% silane aqueous solution. The solution is heated to 40° C. and held for 2 h. During this soaking process, methoxyl groups of 3-[2-(2-Aminoethylamino)ethylamino]propyl-trimethoxysilane react with water via hydrolysis to form silanol groups. It is chemically bonded on the fiber surface via dehydration/condensation reaction with the hydroxyl group of fiber. The 3-[2-(2-Aminoethylamino)ethylamino]propyl-trimethoxysilane can also first self-polymerize into oligomeric structures by silanol self-condensation reactions and then graft onto the fiber surface via-O-linkers. The modified fiber substrate is removed from the solution, taken out for draining water in the air, and transferred to an oven at 60° C. for 2 hours. After complete drying, it is washed with pure water to remove unattached compounds and re-dried at 60° C. for 2 hours to obtain textile/fiber substrate with surface modification of linear PEI molecules and oligomers.

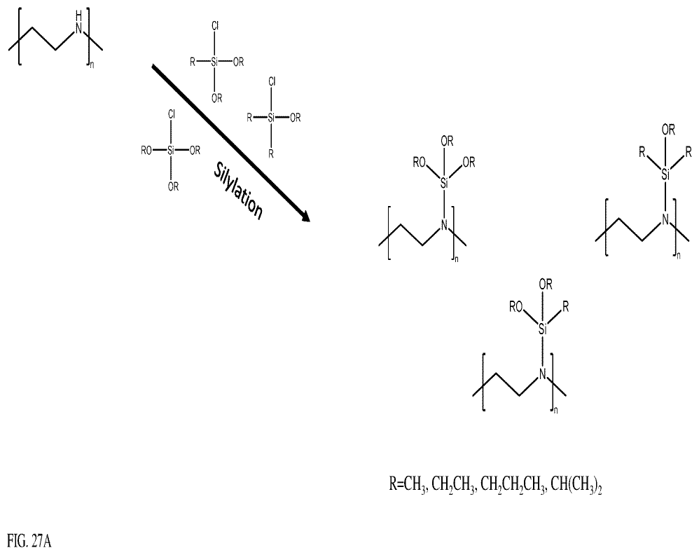

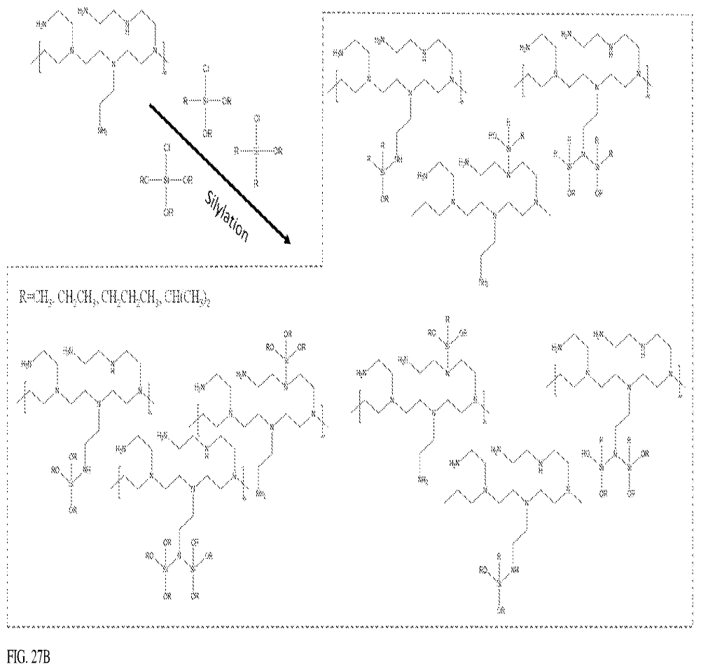

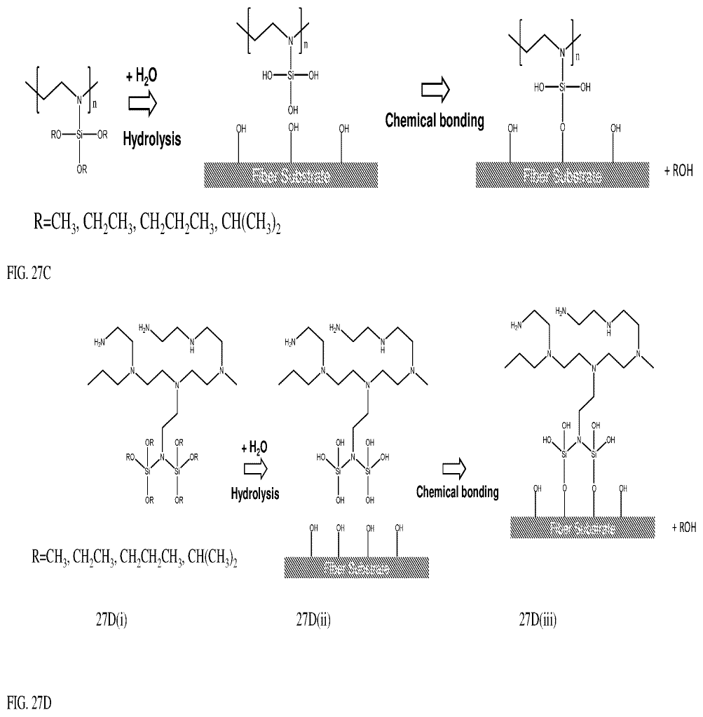

FIG. 27A-27B show example synthetic routes for making various silylated linear or branched PEI compounds via silylation reaction between chloroalkoxysilane and PEI polymers (exemplar cationic polymers).

In an example embodiment, 500 mg of linear PEI polymers is dissolved in 200 mL of ethanol in a sealed vessel. The vessel is placed in an ice bath (0° C.) and nitrogen gas is bubbled into the solution for the removal of oxygen. Then 5 g chlorotriethoxysilane is slowly dripped into the solution over 30 minutes and continuously stirred for 1 hour in the N₂-filled atmosphere at 0° C., followed by stirring at 40° C. for 2 hours. The solution is then poured into an excess amount of diethyl ether to obtain precipitation of the silylated linear PEI polymer, which is collected by filtration and further dried in a vacuum.

In another example embodiment, 10 g of branched PEI polymers is dissolved in 500 mL of ethanol in a sealed vessel. The vessel is placed in an ice bath (0° C.) and nitrogen gas is bubbled into the solution for the removal of oxygen. Then 20 g chlorotriethoxysilane is slowly dripped into the solution over 30 minutes and continuously stirred for 1 hour in the N₂-filled atmosphere at 0° C., followed by stirring at 40° C. for 2 hours. Then 500 mL diethyl ether is poured into the solution, leading to liquid stratification. A separatory funnel is used to obtain the liquid layer containing the silylated branched PEI polymer. The final product is further dried in a vacuum and sealed storage unit.

FIG. 27C-27D shows example synthetic routes reacting silylated linear or branched PEI with a fiber substrate (hydrophobic material). In an example embodiment, 100 mg of silylated linear PEI polymers is dissolved in 100 mL ethanol/water (50/50, w/w) mixture at room temperature to form a Si-PEI solution. Then a fiber substrate, such as 0.30 mm thick 50% polyester 50% cellulose material, is soaked in the Si-PEI solution at room temperature for 30 minutes. and then heated to 40° C. and held for 2 h. During this soaking process, methoxyl groups of the silylated linear PEI polymers react with water via hydrolysis to form silanol groups. The silanol groups chemically bond to the fiber surface via a dehydration/condensation reaction with at least one hydroxyl group of the fiber substrate to form a modified fiber substrate. The modified fiber substrate is taken out for draining of water in air and transferred to an oven at 60° C. for 2 hours. After complete drying, it is washed with pure water to remove excess or unreacted compounds and re-dried at 60° C. for 2 hours to obtain textile/fiber substrate with surface modification of silylated linear PEI polymers (formula 27C (iii)), which has chemical bonding between the silyl groups of the silylated linear PEI polymers and the hydroxyl groups of the fiber substrate.

In another exemplary embodiment, 6 g of silylated branched PEI polymers is dissolved in 100 mL ethanol/water (50/50, w/w) mixture at room temperature. Then a fiber substrate, such as 0.30 mm thick 50% polyester 50% cellulose material, is soaked in the as-prepared solution for 30 minutes. The solution temperature is further increased to 40° C. and held for 2 h. During this soaking process, methoxyl groups react with water via hydrolysis to form silanol groups. It is chemically bonded on the fiber surface via dehydration/condensation reaction with the hydroxyl group of fiber. The modified fiber substrate is taken out for the draining of water in air and transferred to an oven at 60° C. for 2 hours. After complete drying, it is washed with pure water to remove unattached compounds and re-dried at 60° C. for 2 hours to obtain textile/fiber substrate with surface modification of silylated branched PEI polymers (formula 27D (iii)), which has a chemical bonding between the silyl groups of the silylated branched PEI polymers and the hydroxyl groups of the fiber substrate.

### Methods of Designing and Manufacturing New Antimicrobial Compositions

Provided herein is a new disinfectant mechanism of space-charge electret material for capturing and killing microorganisms (such as bacteria and viruses) by synergistic effects of contact electrification, noncontact electrostatic interaction, and interface lipophilicity, to guide the design and fabrication of biocompatible space-charge electret materials with excellent antibacterial, antiviral, bactericidal and virucidal effects based on biocompatible cationic polymers and textile substrates. Space-charge electret materials shall possess both high positive charge density and suitable hydrophobicity to achieve excellent antibacterial, antiviral, bactericidal and virucidal effects. Positive charge density is demonstrated to play a key role on the degree of antibacterial and antiviral activity for a space-charge electret material.

Firstly, the space-charge electret material with high positive charge density attracts the biohazard (such as bacteria and viruses) with negatively charged protein via noncontact electrostatic interaction, leading to the increase of collision rate. Then contact electrification occurs when the drifting negatively-charged biohazard collides with the positively-charged electret, leading to a drastic change of electrostatic potential and sudden increase of electrical stress. The strong electrostatic field pins or traps the biohazard on the positively-charged surface tightly, and the generated inhomogeneous electric stress contributes to the shearing or tearing off the envelope protein and/or other key viral or microbial proteins of the biohazard. During the tight contact, the hydrophobicity of space-charge electret material helps its lipophilic partition insert into the biohazard membrane via Van der Waals interactions, contributing to the destruction of biohazards more easily and quickly. Through the proper choice of textile substrates with suitable structures, space-charge electret materials based on cationic polymer and textile substrates may have high viral and bacterial filtration efficacy. Such kinds of space-charge electret materials can be widely used for air filtering products (such as masks, protective garments, air filters and air purifiers), and personal/home sanitation and hygiene items, such as hand sanitizers, moist towelettes, and toilet papers, home/hotel textiles, and related hygienic disposable items.

### Particular Exemplary Embodiments—Set 1

Provided herein is a new disinfectant mechanism of space-charge electret material for capturing and killing microorganisms (such as bacteria and virus) by synergistic effects of contact electrification, noncontact electrostatic interaction, and interface lipophilicity to guide the design and fabrication of biocompatible space-charge electret materials featuring excellent antibacterial, antiviral, bactericidal and virucidal effects based on biocompatible cationic polymers and textile substrates.

Positive charge density is demonstrated to play a key role on the degree of antibacterial and antiviral activity for a space-charge electret material.

Firstly, the space-charge electret material with high positive charge density attracts a target biohazard (such as bacteria and virus) with negatively charged protein via noncontact electrostatic interaction, leading to an increase in collision rate.

Then contact electrification occurs when the drifting negatively-charged biohazard collides with positively-charged electret, leading to a drastic change of electrostatic potential and sudden increase of electrical stress. The strong electrostatic field leads to the biohazard becoming pinned on the positive charge surface tightly, and the generated inhomogeneous electric stress contributes to the tearing or shearing off of the envelope protein and/or other key viral or microbial proteins of the targeted biohazard.

During the tight contact, the hydrophobicity of space-charge electret material helps its lipophilic partition insert into the biohazard membrane via Van der Walls interactions, contributing to the destruction of biohazards more readily and quickly.

Provided herein is a technical route of using one or more kinds of cationic polymers and hydrophilic fiber/hydrophobic blended textile substrates for the preparation of space-charge electret materials with high charge density and suitable surface hydrophobicity;

Provided herein is a new application of using space-charge electret materials for biocompatible disinfectant/sanitizers with excellent antibacterial, antiviral, bactericidal and virucidal effects;

Provided herein is a new application of using space-charge electret materials for air filters with high viral filtration efficacy and bacterial filtration efficacy;

To achieve excellent antibacterial, antiviral, bactericidal and virucidal effects as well as high viral/bacterial filtration efficiency, the positive charge density of textile substrates treated with cationic polymers is over 9.59 nC cm⁻². In some embodiments, textile substrate consists of hydrophilic fiber (such as cellulose) and hydrophobic fibers (such as polyester).

Provided herein is a method and device for evaluating the contact electrification of space-charge electret materials.

Provided herein is a parameter of positive charge density for quantitative evaluation of the degree of contact electrification.

Provided herein is a device for measuring positive charge of a space-charge electret material is based on a double-layered device mainly consisted of a bottom acrylic plate fixed with a 6 cm×6 cm adhesive electrode layer and an upper acrylic plate fixed with an identical-size reference material/electrode layer. PTFE film is fixed as reference material. The testing samples can be woven/knitted/nonwoven fabric samples and films.

When testing, a sample (such as nonwoven textile substrate surface modified with space-charge electret material) is adhered to an adhesive electrode on the bottom acrylic plate smoothly and tightly. The upper acrylic plate can be controlled by machine to contact/impact the bottom acrylic plate repeatedly. This allows the contact between the surface of space-charge electret with the material-modified textile (modified with PTFE) surface by external pressure and enables their separation after the release of external pressure.

An electrometer is connected to the electrodes for real-time monitoring and measurement of the charge variation, and stable charge curves produced and measured over repeated contacts and separations are recorded for further analysis.

Generally, a maximum charge value appears during the contact state while a minimum charge value shows during the separation state. The value difference during the contact and separation states can be determined as positive charges generated by contact electrification. The positive charge density is calculated by using positive charges divided with the effective contact area (e.g., 6 cm×6 cm) for the quantitative evaluation of the degree of contact electrification.

While various embodiments of the invention have been described, it will be apparent to those of ordinary skill in the art that many more embodiments and implementations are possible that are within the scope of the invention. In addition, the various features, elements, and embodiments described herein may be claimed or combined in any combination or arrangement.

1-10. (canceled)

11: A method of manufacturing an antiviral material, comprising:
dissolving a space-charge electret material in a suitable solvent to form a space-charge electret material/solvent mixture, wherein the concentration of the space-charge electret material in the solvent is 0.195%-10%;
applying the space-charge electret material/solvent mixture to a hydrophobic substrate material by dip-coating and/or spraying to coat the hydrophobic substrate material;
subjecting the resultant coated hydrophobic material to a tensioning process, wherein the tensioning process comprises one of more of steaming, heating, pressing, and/or subjecting to pressure; and washing the material to remove unbonded mixture components.

12: The method of claim 11, wherein the space-charge electret material is dissolved in a solvent with no added salt.

13: The method of claim 12, wherein the solvent is water.

14: The method of claim 11, wherein the space-charge electret material is 0.195%-10% polyethylenimine.

15: The method of claim 14, wherein the space-charge electret material is substantially 2%-8% polyethylenimine.

16: The method of claim 11, wherein the space-charge electret material/solvent mixture is spread uniformly upon the hydrophobic substrate material to form a polymer-soaked substrate material, further wherein the polymer-soaked substrate is heated at 50-160 degrees celsius for at least 5 seconds.

17: The method of claim 11, wherein the hydrophobic substrate material is one or more of a cotton-polyester blend, cotton, polyester, a cellulose-polyester blend, cellulose, spunlace, polypropylene (PP), polyactic acid (PLA), polyethylene (PE), polyvinyl chloride (PVC), acrylonitrile butadiene styrene (ABS), poly(methyl methacrylate) (PMMA), polytetrafluoroethylene (PTFE), silicone, latex, nylon, or glass.

18: The method of claim 17, wherein the hydrophobic substrate material is one or more of a cotton-polyester blend, cotton, polyester, cellulose, or spunlace.

19: The method of claim 11, wherein the resultant coated hydrophobic material has a minimum average positive surface charge of 2-35 nC cm⁻².

20: The method of claim 11, wherein the material is formed as a porous sheet, membrane, woven fabric or nonwoven fabric.
